(19) United States
(12) Patent Application Publication
(10) Pub. No.: US 2009/0276296 A1
(43) Pub. Date: Nov. 5, 2009

(54) Business profit resource optimization system and method

(75) Inventor: Andrew R. Spriegel, Massillion, OH (US)

Correspondence Address: Andrew R. Spriegel, 8064 Clifton Court Circle NW, Massillon, OH, 44646, US

(73) Assignee: ANOVA INNOVATIONS, LLC

(21) Appl. No.: 12/149,469

(22) Filed: May 1, 2008

(51) Int. Cl. G06Q 90/00

(52) U.S. Cl. 705/11

(57) ABSTRACT

A business profit and resource optimization system that calculates an employee evaluation, comprising an input component that is utilized to input assessment data related to characteristics for a currently assessed employee, utilizing the assessment data from a plurality of evaluators, an idea component that analyzes ideas of the currently assessed employee in terms of idea success year over year and a display component that interacts with the input component and allows viewing of an employees evaluation.

### REFERENCE TO RELATED APPLICATION

This application claims priority to and the benefit of U.S. Provisional Application Ser. No. 60/926,821 which was filed Apr. 30, 2007, entitled BUSINESS PROFIT AND RESOURCE OPTIMIZATION SYSTEM AND METHOD, the entirety of which is hereby incorporated by reference as if fully set forth herein.

### TECHNICAL FIELD

The following description relates generally to business management and more particularly to systems and methods employed to assist an organization in the evaluation of an employee, as a means to assess whether organizational goals are reached, the proper people are recognized, profits met, employee satisfaction enhanced and to optimize overall business objectives.

### BACKGROUND

Managing a workforce and evaluating employees is most often based on individual impressions and/or misconceptions rather than facts. Companies often realize profits delivering products or services in the marketplace and yet fail to optimize those profits by failing to utilize the company's full human potential. Many companies manage employees without understanding what actually motivates or energizes them. For example, employees are promoted to management positions where other co-workers have a difficult time understanding why those employees were promoted, let alone part of the organization. In those positions, poor managers can often damage the morale and/or operation of the company. Many companies use different techniques to manage and promote employees within an organization with varying success.

One typical approach for evaluating and promoting employees is to utilize an annual employee evaluation. Employee evaluations, for example, help the individual understand what the company expects of them and whether they have met those expectations in that annual period, however the evaluations often miss the mark. At the time of the evaluation, the employee often receives feedback, praise, and/or criticism for their work; and any shortfalls in their performance or conduct. The company recognizes and rewards “good employees” and identifies and coaches “employees that fall short”. This method of communication “ensures” that the company “stays in tune” with the needs and concerns of the workforce. There are several challenges, however, to meeting the goals of the annual performance review. For example, the managers performing the evaluation are often far removed from the employee's work they are evaluating. In addition, work performance is a continuum and not an annual event and the evaluation process often misses the growth, development, etc., of an employee year-after-year.

Another significant limitation of current one-on-one evaluation systems is that the employee most likely works with a wide range of individuals who are not involved in the evaluation process. Those individuals are most likely to see the employee in his/her working environment and the employee's performance (e.g., respect for others, technical ability, management ability, leadership skills, etc.). The employee may receive an evaluation from his/her immediate supervisor that is significantly different from the evaluation he/she would receive from those individuals the employee works with routinely. This can prevent an employee from receiving the appropriate recognition for many accomplishments made during the year. This can have an impact on an employee's sense of fair treatment in the job and can result in a discontinuity between the employee's own self-assessment and the evaluation outcome, often leading to frustration, loss of morale, employee turnover, and the like.

Yet another important limitation in the employee evaluation process is documenting what ideas, programs, decisions, etc., (referred to as “ideas”) the employee has suggested or championed while in the organization. It is critical in an information-based economy that the employees who generate and promote profitable ideas are rewarded, retained, promoted, etc. Often ideas come to fruition several years after the ideas were suggested and/or championed. At that time the ideas are realized it is difficult to recall the person who was the originator of the idea. Additionally, when a program or idea is successful people often step forward, frequently management individuals, to take ownership for the suggestion, even though they may not have been involved at all. On the other hand, if an idea turns out to be a disaster or goes badly, people avoid any association with the idea, or worse, blame the idea on someone that did not have any involvement whatsoever in the original idea. Therefore, companies often run often by individuals who are skillful at taking credit for successes and avoiding failures whether or not they are adept at moving the company forward profitably with good ideas.

An additional noteworthy drawback, in the typical evaluation system, is how meeting timelines and schedules are established. Managers often establish unrealistic timelines. Though the employee may have been doing an excellent job on a project he received a poor evaluation due to an unrealistic timeline that is difficult if not impossible to meet. In today's competitive environment, meeting timelines is becoming more and more critical. In many evaluations, there is no feedback mechanism to let the employee or manager know that the timelines are practical or unrealistic. This often results in employee frustration knowing that a timeline cannot be met, as opposed to striving to meet an aggressive timeline. The company must understand which employees are able to create and meet critical timelines and if timelines are not met, why they were not met. Companies seldom go back and look at why the deadline was not met so that unrealistic schedules are perpetuated which can result in, for example, employee frustration, wasted resources, generating multiple schedules, unmet customer needs, false expectations, and the like. Managers and employees should be rewarded or recognized when a deadline is met or instructed when a timeline is not met on how to establish realistic deadlines for work completion.

Yet another limitation in an evaluation system is that the employee often does not know what the company is paying out to compensate the employee in terms of total compensation, including fringe benefits. Many employees have no idea how much the company pays to compensate them on an annual basis. Employees are often unaware of, healthcare insurance costs, dental insurance cost, workers compensation, in-house training, out of house training, tuition reimbursement, overhead, vacation, paid holidays, discretionary holidays, 401k, taxes, liability insurance, social security, Medicare, Employee Stock Purchase Plans (ESPP), turnover costs, stock options, pensions, parking costs, recruitment firm fees, and the like. Making the employee aware of the additional compensation would result in greater satisfaction in the job and greater awareness of the need for strong performance.

Another limitation in many conventional evaluation systems is that the evaluations often take place very late in the year. Evaluations are often seen as an after thought or the evaluations are finalized after the “real work” is done. There is often no year over year evaluations performed on the employees or business groups as entities. In addition, there is no correlation drawn between evaluations and the enterprise meeting business goals. Performance can and/or should be evaluated on a continuum and not based just on a calendar year. It is critical for the employee to understand how they are meeting performance goals throughout the year and how those goals tie into the company's overall objectives.

A additional evaluation approach has been termed a “360-degree evaluation” which is a commonly used tool in human resource circles, as a mechanism for evaluating an employee's performance based on feedback from, for example, supervisors, co-workers, partners, subordinates, consultants, etc. This method of collecting data can be a motivational source for employees because it provides a more comprehensive assessment of how the employee and the employee's performance is viewed by a variety of individuals. The “360-degree evaluation” method uses confidential input from various people who can respond to how an employee performs on the job.

A noteworthy limitation with respect to the “360-degree evaluation” is that the feedback process is usually anonymous. Therefore, employees receiving feedback at an evaluation have no recourse if they want to have that information interpreted. They have no one to ask for clarification of unclear comments or more information about particular ratings and their basis. In addition, there is often insufficient training and process understanding of employees who will participate in the 360-degree evaluation. Those employees need training about the process, how to provide constructive feedback, how to interpret results, and the like. Failure to provide the appropriate amount of training and information can have a major negative impact on the evaluation process. For the “360-feedback” process to work, it must be associated with the overall strategic aims of the organization. If the company has identified competencies or they have comprehensive job descriptions, people need to give feedback on their performance with respect to the expected competencies and job duties.

Communication in both large and small companies is a two-way process that evaluations support. Employees are encouraged by management to speak up, help set expectations, band communicate barriers and opportunities to achieving company success. Encouraging employees to communicate with the senior team can help each group understand each other and what can be done, for example, for a budget, regarding schedules, setting expectations, and the like. Corporations ask employees to proactively tell the management team what they are struggling with and how managers can help, reinforcing the company's vision and how current objectives can contribute to that vision. Unfortunately, employees are often silent with respect to company shortfalls and needs due to fear of reprisals, wanting to remain anonymous, etc.

Regardless of which evaluation approach is taken, it is essential that employees understand how their contributions result in overall achievement of company goals, and how their actions affect how the organization is perceived both within and outside the organization. Employees can be left feeling vulnerable and uncertain when their concerns are ignored or mismanaged. This can lead to, for example, attendance issues, employee retention problems, poor customer service and low productivity. Effective internal communication is critical to improved performance and successful change management strategies. A poor evaluation process can often damage the communication process when employees see inconsistencies between actual performance and perception or evaluation of that performance.

Therefore, there is a need to overcome the aforementioned, as well as other, deficiencies associated with conventional evaluation systems.

### BRIEF SUMMARY

The following presents a simplified summary of one or more embodiments in order to provide a basic understanding of some aspects of such embodiments. This summary is not an extensive overview of the one or more embodiments, and is not intended to identify key or critical elements nor to delineate the scope of the embodiments. Its sole purpose is to present some concepts of the described embodiments in a simplified form as a prelude to the more detailed description presented later.

It is an object of the present invention in one embodiment or aspect that provides a Human Resource Management Optimization System, which includes assessments of employees by individuals selected by employing interaction components. Those individuals can include customers, suppliers, co-workers, managers, contractors, consultants, subordinates, administrators, etc.

In another embodiment or aspect, to provide a business profit and resource optimization system that calculates an employee evaluation, comprising an input component that is utilized to input assessment data related to characteristics for a currently assessed employee utilizing the assessment data from a plurality of evaluators, an idea component that analyzes ideas of the currently assessed employee in terms of idea success year over year and a display component that interacts with the input component and allows viewing of an employees evaluation.

It is yet another object of the present invention, in another embodiment or aspect, to provide An employee idea tracking system that facilitates analyzing company ideas, comprising an idea analysis component that is utilized to input and store a current assessed employee ideas on a periodic basis during the length of the employees employment, wherein idea analysis component determines the value of the employee ideas and an annualized score is assigned to the current assessed employee based upon the value of the employee ideas that is part of an annual evaluation.

It is a further object of the invention, in another embodiment or aspect, to provide a timeline accuracy system wherein a timeline is evaluated for accuracy in delivering organizational goals.

In yet another aspect, a method of evaluating an employee, comprising: opening an employee to be evaluated performance file on a periodic basis by an evaluator, reviewing each characteristic for the employee to be evaluated, scoring each characteristic for the employee to be evaluated, saving the characteristics for the employee to be evaluated in the data base and comparing the annual scores for the employee to be evaluated for the entire length of employment of the employee.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments employed. Other advantages and novel features will become apparent from the following detailed description when considered in conjunction with the drawings and the disclosed embodiments intended to include all such aspects and their equivalents.

### BRIEF DESCRIPTION OF THE DRAWINGS

FIG. 1 illustrates according to one aspect of the invention, an employee evaluation system that can aid the employee and organization in understanding the employee's functional and social skills, as well as competency in executing the various facets of their position;

FIG. 2 illustrates an exemplary evaluation system employing the one or more employee self-evaluation embodiments disclosed herein, according to another aspect of the invention;

FIG. 3 illustrates yet another aspect of the invention, an employee evaluation input system in accordance with one or more embodiments;

FIG. 4 illustrates another aspect of the invention; an employee evaluation company display system employing one or more embodiments;

FIG. 5 illustrates yet another aspect of the invention, exemplary system employing the one or more embodiments disclosed herein, according to an aspect of the invention;

FIG. 6 illustrates another aspect of the invention, an immediate circle of influence for a given employee in accordance with an aspect of the various embodiments;

FIG. 7 illustrates yet another aspect of the invention, a system of layers indicating a total circle of influence, each configured to show the employees effect on the various individuals and business groups;

FIG. 8 illustrates yet another exemplary system for determining employee interactions in one particular embodiment of the invention;

FIG. 9 illustrates yet another aspect of the invention, an exemplary system employing RFID badges and RFID readers to determine interactions in accordance with an aspect of the various embodiments;

FIG. 10 illustrates an exemplary system that can display employee to business group interaction in accordance with the various disclosed embodiments according to yet another aspect of the invention;

FIG. 11 illustrates a business group employee evaluation system in accordance with the various disclosed embodiments;

FIG. 12 illustrates yet another aspect of the invention, a year-over-year employee evaluation system in accordance with one or more embodiment;

FIG. 13 illustrates an organizational system in accordance with the various disclosed embodiments illustrating yet another aspect of the invention;

FIG. 14 illustrates an exemplary evaluation display system for determining employee performance in one particular embodiment of the invention;

FIG. 15 illustrates an exemplary system employing the one or more embodiments disclosed herein;

FIG. 16 illustrates an idea tracking system in accordance with the employee evaluation in accordance with the various disclosed embodiments of the invention;

FIG. 17 illustrates yet another aspect of the invention, a company achieved goals display system in accordance with the employee evaluation in accordance with the various disclosed embodiments;

FIG. 18 illustrates another aspect of the invention, a employee key goal display system in accordance with one or more embodiments;

FIG. 19 illustrates yet another aspect of the invention, an organization key goal display system employed with one or more embodiments;

FIG. 20 illustrates a methodology for an evaluation system based chosen characteristics in accordance with some embodiments disclosed herein;

FIG. 21 illustrates methodology of evaluating an employee in accordance with one or more embodiments of the present invention;

FIG. 22 illustrates yet another aspect of the invention, an exemplary networking environment, wherein novel aspects of the claimed subject matter can be employed; and

FIG. 23 illustrates an aspect of the invention, an exemplary operating environment that can be employed in accordance with the claimed subject matter.

### DESCRIPTION OF VARIOUS TERMS

Terminology—Before describing a BUSINESS PROFIT AND RESOURCE OPTIMIZATION SYSTEM AND METHOD and the operations performed to assess and potentially promote employees, some introductory concepts and terminology are explained.

“Assessment” is a term used to refer to an ongoing and/or real-time evaluation.

“Characteristics” refers to traits that are rated for the currently assessed employee (e.g., management skill, leadership, negotiation skill, technical skill, etc.). The characteristics can be selected and/or added to by the user.

“Currently Assessed Employee” is the employee that is being evaluated or assessed by other individuals or business groups.

“Evaluator” is the individual or business group involved in the currently assessed employee's evaluation.

“Interaction” is communication or action between individuals or employees and business groups; or between business groups.

“Leadership skill” is the capacity and ability to lead others.

“Negotiation skill” refers to the capacity and ability of resolving conflicts or disputes among individuals.

### DETAILED DESCRIPTION

Various embodiments are described with reference to the drawings, wherein like reference numerals are used to refer to like elements throughout. In the following description, for purposes of explanation, numerous specific details are set forth in order to provide a thorough understanding of one or more aspects. It may be evident, however, that various embodiments practiced without these specific details. Additionally, well-known structures and devices are shown in block-diagram form in order to facilitate describing these embodiments.

As utilized in this application, the terms “component,” “system,” and the like is intended to refer to a computer-related entity, either hardware, a combination of hardware and software, software in execution, and/or firmware. For example, a component can be, but is not limited to being, a process running on a processor, a processor, an object, an executable, a thread of execution, a program, and/or a computer. By way of illustration, both an application running on a server and the server can be a component. One or more components can reside within a process and a component can be localized on one computer and/or distributed between two or more computers.

The word “exemplary” is used herein to mean serving as an example, instance, or illustration. Any aspect or design described herein as “exemplary” is not to be construed as preferred or advantageous over other aspects or designs. Furthermore, the one or more embodiments is implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, a carrier wave can be employed to carry computer-readable electronic data such as those used in transmitting and receiving electronic mail or in accessing a network such as the Internet or a local area network (LAN). Of course, those skilled in the art will recognize many modifications are made to this configuration without departing from the scope or spirit of the disclosed embodiments.

Artificial intelligence based systems (e.g., explicitly and/or implicitly trained classifiers) can be employed in connection with performing inference and/or probabilistic determinations and/or statistical-based determinations as described herein. As used herein, the term “inference” refers generally to the process of reasoning about or inferring states of the system, environment, and/or user from a set of observations as captured through events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject embodiments.

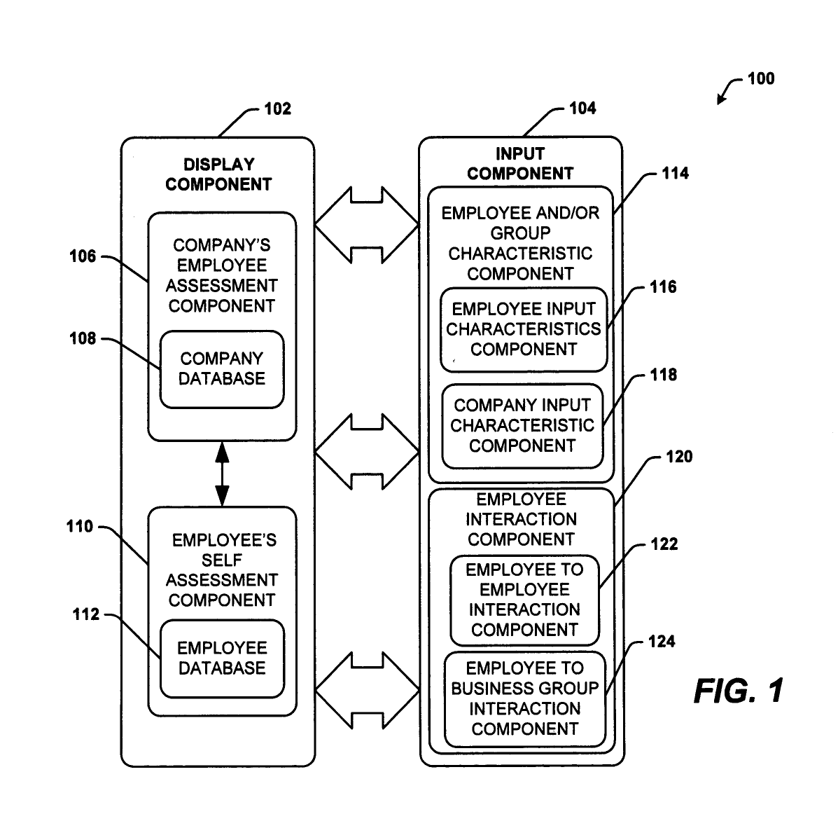

Referring now to the drawings, FIG. 1 illustrates a block diagram of an exemplary human resource system (HRS) 100 that can assist both an employee and a company optimize, for example, the employee's potential, skill, self awareness, company profits, and the like. The system can be employed in almost any business, such as, for example, within an industrial, medical, automotive, aerospace, sales group, marketing organization, etc. The HRS 100 can include a display component 102 that interacts with an input component 104 thereto. The display component 102 can include a company's employee assessment component 106 that can be configured to record and display data related to other employees or business group's evaluation of a currently assessed employee (CAE), the employee being evaluated. The data recorded within the HRS 100 can include scores, for example relating to, the CAE's accountability, adaptability, attendance, attitude, cooperation, creativeness, dependability, honesty, human relations, idea generation, initiative, intelligence, interpersonal relationships, judgment, leadership, management skill, organization, planning, presentation ability, punctuality, quantity of work, quality of work, reliability, respect for others, teamwork, etc. These various scores can reside in a company's employee assessment component 106 within a company database 108 and/or in an employee's self-assessment component 110 within an employee database 112. The employee's self-assessment component 110, for example, can be employed to store the employee's own self-evaluation.

The input component 104 can facilitate the entering of information regarding employees and/or business groups evaluations. The employee's self assessment component 110 can be employed in the HRS 100 to determine the employee's assessment of himself in the workplace, for example, the employee can be a co-worker, a sales person, an engineer, a customer, an employee, a regulatory representative, a legal representative, a manager, a marketing person, a key employee, a consultant, a contractor, a supervisor, a supplier, a business group, and the like. The self-assessment data can be input on a periodic basis, for example, daily, weekly, monthly, quarterly, annually, etc., and the evaluation input frequency can be specified by the company. Alternatively or in addition, software components and/or programming software within the input component 104 can gather and store data (e.g., RFID badge interactions, times spent at a terminal, employee absences, time spent by employees in a specific location, time spent in specific meetings, etc.) in the employee database 112 of the display component 102, for example.

By way of illustration, and not limitation, the input component 104 and/or the employee assessment component 106 can include nonvolatile and/or volatile memory. Suitable nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

For example, the human resource system 100 can employ the company's employee assessment component 106 that can employ a bar graph, a scatter plot, a pie graph, and the like. The employee in assessing his own performance can utilize an employee and/or group characteristic component 114. The currently assessed employee can enter grades regarding his own perceived characteristics, for example, technical skill, leadership, respect for coworkers, honesty, etc. A company input characteristic component 118 can be utilized by employees to input or capture their assessment of other employees and/or business group characteristics that, for example, can be part of a checklist in the company input characteristic component 118 or can be entered manually. In more detail, the characteristics can be entered employing a PDA, a cell phone, a computer, an iPod, and the like, for example. The characteristics captured in the employee characteristic component 114 or the company input characteristic component 118 can be stored in the company database 108 and/or the employee and/or group characteristic component 114 (or in another retrievable format).

In another example, the CAE's manager during the evaluation can review with the CAE those individuals that have provided feedback regarding the CAE's evaluation in terms of employee characteristics. The currently assessed employee may have strong characteristics (defined critical to his position by the company), such as for example, leadership skills, respected by others, management skills, etc., and weak skills, e.g., 3-D modeling, structural analysis, and the like. The manager can compare the employee's assessment of his own performance to the company's assessment of the employee being evaluated. This technique can reveal areas where the employee believes he has stronger skills than the skills his fellow employees believe he has and/or areas where the employee believes his skills are weaker whereas his fellow employees those skills are in fact stronger.

Additionally or alternatively, an algorithm within the company database 108 and/or the employee database 112 can determine the best location to store data within the HRS 100 based upon storage capacity, ease of storage, ease of storage retrieval, and the like. It is to be appreciated and understood that the company database 110 and/or the employee database 114 can make use of various communication paths to obtain data and employee characteristics. Such communications paths can be but are not limited to the Internet, hard-wired networks, wireless networks, local area network (LAN), wide area network (WAN), Ethernet or other communication paths. It is also to be understood and appreciated that the term system as used herein can refer to human resource systems, including teams, individuals, business groups, testing teams, management groups, tiger teams, several teams integrated together, and the like.

FIG. 1 illustrates a HRS 100 that can facilitate the storing and displaying of employee to employee and employee to business group interactions in e.g., computer and/or digital device memory of the company input characteristic component 118. An employee to employee interaction component 122 and an employee to business group interaction component 124 can often work in conjunction with each other and together the total interactions can be stored in the memory of, for example, the company database 108 and/or the employee database 114. According to one exemplary aspect of the invention, the employee to employee interaction component 120 can determine the amount of interactions that may have actually taken place between employees or that are predicted to have taken place based on organization charts, RFID badge contact, meetings attended, probability, and the like. The employee to business group interaction component 124 can determine the quantity of interactions in a similar manner between an employee and a business group.

The employee to employee interaction component 122 and the employee to business group interaction component 124 can work in conjunction with the input component 104 to establish weighted averages for characteristics based on the number of interactions, for example, the greater the number of interactions, the higher the weighted factor, for example.

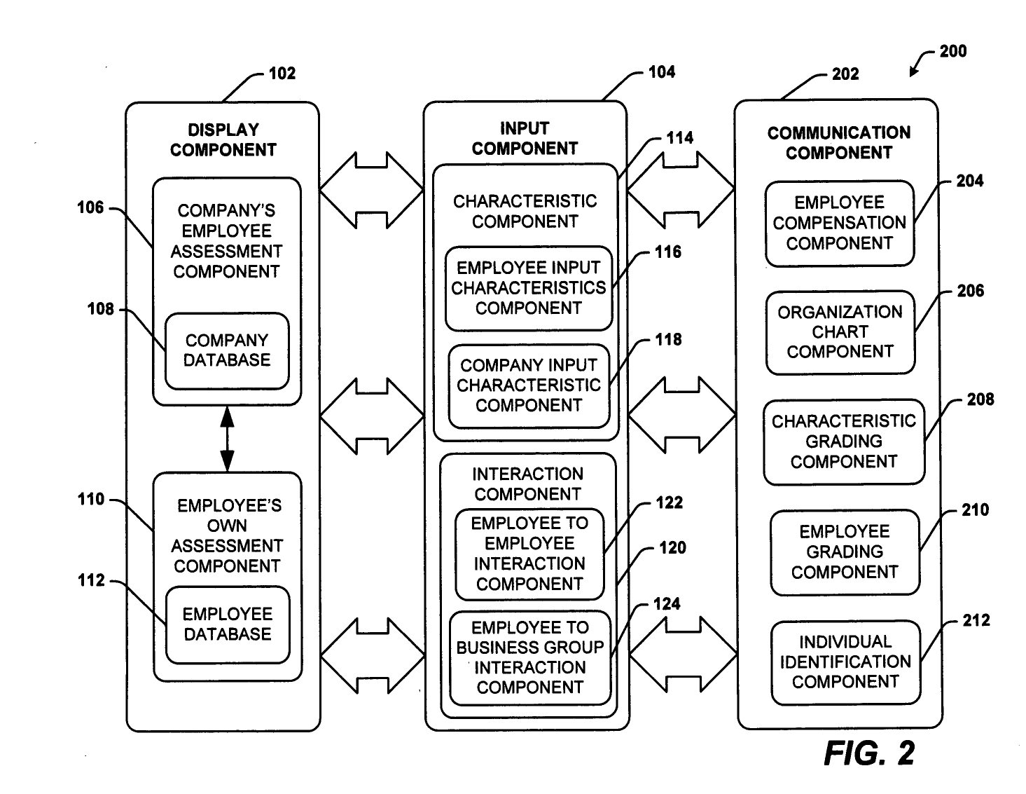

Now referring to FIG. 2, a communication component 106 can sort data already in the human resource system 100 and filter out data that is, for instance, used less frequently, within a certain time period without being “touched”, which is identified by the input component 104 as not important, etc. According to one aspect of the present invention, total employee compensation can be stored in an employee compensation component 204 (e.g., salary, health benefits, prescriptions, 401k plans, stock options, paid vacation, sick days, unemployment insurance, workers comp., long term disability, life insurance, short term disability, etc.), where total amount of pay can be communicated to the employee to help them understand how much they are actually paid. In one particular example, an organization chart component 206 can be created and updated by the communication component 202. An employee can be selected by choosing the employees name or picture to display the employee's own assessed characteristics or those assessed by other employees and/or business groups, for example.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed (e.g., recording an event). In the case of timestamps, offsets and events for example, attributes can be file types or other data-specific attributes derived from the file types and/or contents, and the classes can be categories or areas of interest.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, and probabilistic classification models providing different patterns of independence can be employed. Classification as used herein also is inclusive of statistical regression that is employed to develop models of priority.

As will be readily appreciated from the subject specification, classifiers can be employed that are explicitly trained (e.g., by a generic training data) as well as implicitly trained (e.g., by observing user behavior, receiving extrinsic information). For example, SVM's can be configured through a learning or training phase within a classifier constructor and feature selection module. In other words, the use of expert systems, fuzzy logic, support vector machines, greedy search algorithms, rule-based systems, Bayesian models (e.g., Bayesian networks), neural networks, other non-linear training techniques, data fusion, utility-based analytical systems, systems employing Bayesian models, etc. are contemplated and are intended to fall within the scope of the hereto appended claims.

Other implementations of AI could include alternative embodiments whereby based upon a learned or predicted user intention, the system can prompt users to backup employee databases 112 with the least available memory, based on data within the company database 108 of the company's employee assessment component 106. Likewise, an optional AI component can remove data in the company database 110 and/or employee database 114 to increase the amount of memory in the databases. The data to be removed from the company database 110 and/or employee database 112 can be determined by the AI component without human interaction. The interaction between individuals can be tracked in various ways by employing an employee interaction component 120. An interaction number can be calculated based on several factors, for example, individuals working in the same group (e.g., engineering, marketing, sales, promotion, advertising, etc.), a supervisor/supervisee relationship, relationships based on organization charts, interactions tracked utilizing RFID tags in badges, and the like. The higher the interaction number the greater impact or weight the interaction number can have on the company's employee assessment. The interaction between a business group (e.g., management) and the employee can be evaluated utilizing an employee to business group interaction component 124. The values can be determined by business groups performing semi-annual or annual employee evaluations or by individuals within the business group performing evaluations and the number being rolled up into a business group number.

Illustrated in FIG. 2 is an exemplary communication system 200 that can be utilized in accordance with an aspect of the various embodiments. An exemplary communication component 202 can be utilized in connection with an input component 104 and a display component 206 to communicate information to the currently assessed employee, company personnel, etc. The communication component 202 can contain an employee compensation component 208 that provides the employee with a clear indication of what the employee is actually compensated in addition to the employee's salary. The employee compensation component 208 can contain an algorithm that calculates what the company actually pays to keep that employee on payroll. That compensation can include internal training costs, external training costs, health insurance costs, prescription plans, HR hiring costs, lunch reimbursements, company giveaways, company car, stock options, vision care, dental insurance cost, profit sharing, bonus programs, workers compensation, state taxes, payroll costs, employee insurance, business cards, employee computer, employee software, books, coffee, company parties, tuition reimbursement, overhead, vacation, paid holidays, discretionary holidays, sick days, and the like. By helping the employee to realize the actual costs involved the company can further motivate the employee. The total employ compensation can be displayed utilizing the display component 102.

An organization chart component 206 can be employed to help the employee understand where he fits in the organization and the impact he has on the organization. The organization chart component 206 can provide various metrics to the employee such as the revenue generated by his team (e.g., the employee and his subordinates), the turnover rate of his team vs. others in the organization, the number of new products generated by “his team”, his “value” to the organization, a link to various charts etc.

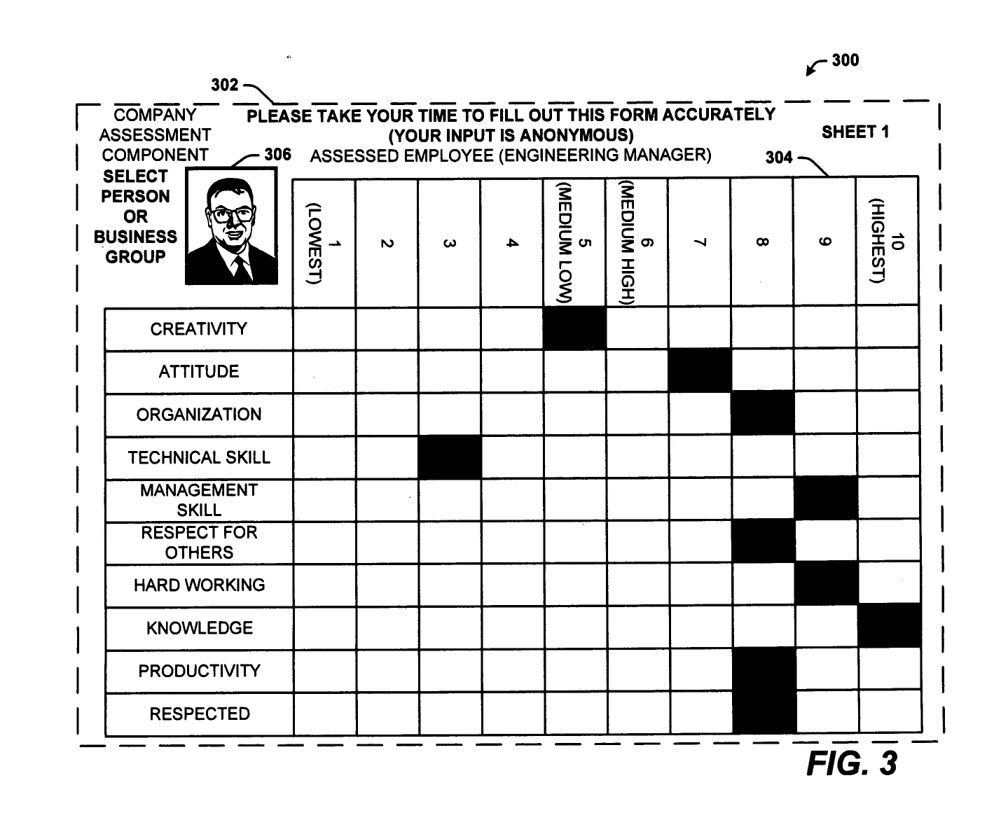

Referring now to FIG. 3, illustrated in an exemplary company assessment system (CAS) 300 that can be employed in connection in accordance with an aspect of the various embodiments. The CAS 300 can include a company evaluation component (CAC) 302 that can operate in conjunction with the display component (not shown) to accurately gather the company's assessment of an employee or a business group that is entered into the CAS 300 and, to display those results across, for example, a network (not shown), to individuals allowed access to the CAS 300. The CAS 300 can include evaluations of anywhere from a single employee, to an entire business unit, to multiple business groups integrated together and the like. The employee or business group assessment can include graded characteristics such as, leadership, technical ability, 3-D modeling skill, interpersonal skills, sales ability, honesty, respect for fellow workers, and the like.

In one example, the company assessment component 302 can be shown on a computer terminal employing a form(s) 304 for the selected employee and/or business group 306. An individual performing the assessment can make selections on the form(s) utilizing for example, a light pen, a pointer, a key pad, arrow keys, a voice command, etc. In another example, each characteristic can be selected employing a grading system of 1 to 10 with a 10 being the highest possible grade and an 1 being the lowest possible grade. The person doing the evaluating might consider the currently assessed employee to have average creativity and therefore might apply a characteristic rating of a 5 or 6. The person doing the evaluation could choose the rankings based on their perception of the individual. An algorithm could determine if the characteristic input component was filled in properly, e.g., are all of the boxes filled in, is one characteristic filled in twice, etc.

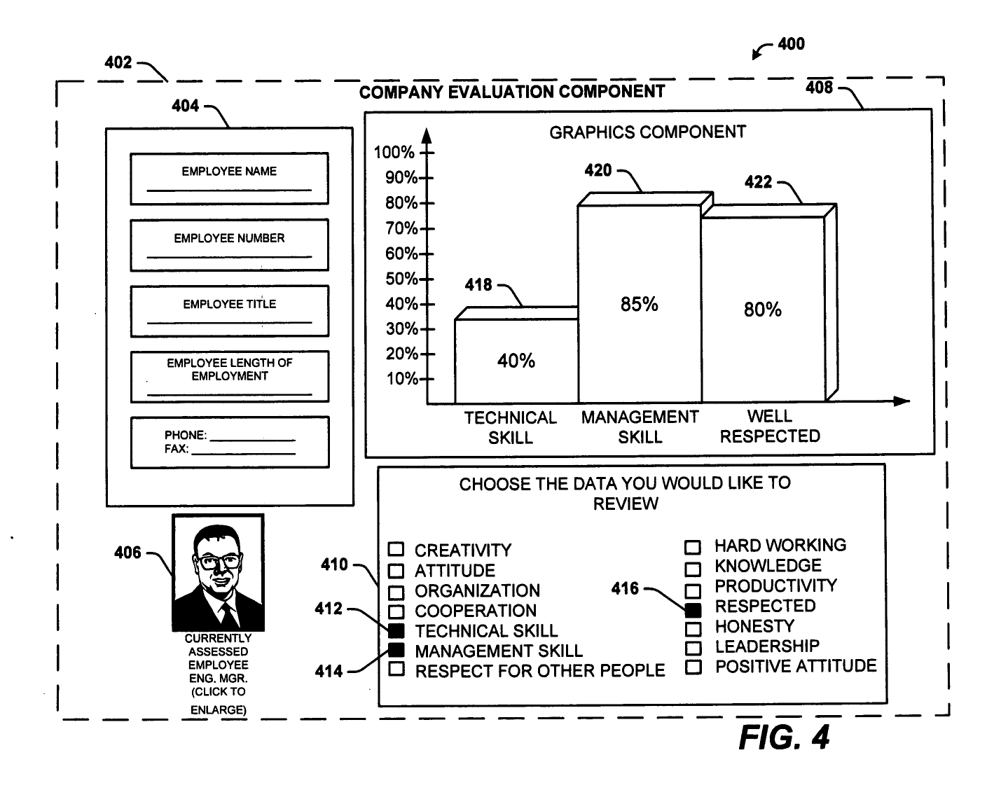

FIG. 4 illustrates a company evaluation system 400, employing the one or more embodiments disclosed herein in a human resource optimization environment. The company evaluation component 402 can include an identifying component 404 that allows data to be input, such as, employee name, employee title, etc. The employee or group identifier 406 can be a photograph, a title block or the like. The identifying component 404 and the group identifier 406 can be used to help an evaluator to recognize the individual they are evaluating. Other identifiers can be used as well, such as, an organization chart, a recording of the persons voice, a video of the person being evaluated, etc. A graphics component 408 can be included in the company evaluation component 402 to graphically display the currently assessed employee's selected characteristics (e.g., knowledge, respect for others, skilled negotiator, etc.). The company evaluation component 402 can store data directly in a company database and the graphics component 408 to store and display both characteristic data regarding either employee or business group characteristic data. For instance, at a first point in time the graphics component 408 can display the selected characteristic from a selection component 410 and can display the data in graphical format in the graphics component 408. The graphics component 408 can be, for example, a computer terminal, a PDA, a cell phone, an iPod, a laptop computer, cameras and the like. At a second point in time the graphics component 408 can employ an algorithm (or multiple algorithms) or other techniques to change the graphical display exhibited on the screen, for example.

In one example, technical skill 412, management skill 414 and well respected 416 can be chosen from the selection component 410 by checking a box associated those factors. The graphics component 408 can then display those characteristics employing a bar chart. A technical skill bar 418 can indicate that the average grade all the individuals or business groups for the CAE is 40% for technical skill 412. Whereas, a management skill bar 420 can show that the CAE might have an average rating of 85% that can indicate that those individuals or business groups doing the evaluating believe the CAE is a much better manager than a technical person. A well respected bar 422 can indicate an average value of 80% which can indicate that the CAE for the most part well respected. An algorithm can be used to determine, based on selected criteria, for example, that the currently assessed employee is well placed as an engineering manager within the organization, he is a good candidate for promotion, his technical skills are too low for a principal engineering position, and the like. In yet another example, the company can obtain a much deeper and broader evaluation of an individual than is typically obtained in an evaluation (e.g., 360 evaluation) and it can also eliminate the usual bias that is introduced by cronyism, favoritism (“brown-nosing”), etc. In yet another example, the evaluations can be straight one to one evaluations or the various employee evaluations can be weighted, for example, the longer the association between individuals, the greater the weight given to that evaluation; the more the interactions between parties, the greater the weight; a management/subordinate relationship can be given greater weight, etc.

According to at least one embodiment, any changes to the employee or business group characteristics can be recorded in either the company database or the employee database or both. Thus, it is understood that the databases can store data related to employee or business groups (e.g., cooperation, attitude, respect for others, innovative approach to products, high skill level, enthusiasm, creativity, etc.). For instance, the company and employee databases can be downloaded or backed up on a regular basis to ensure ready access to the characteristic data. Furthermore, while for ease of explanation the databases are described as recording all of the characteristics related to the employees and business units, any suitable combination of characteristic data is contemplated and intended to fall under the scope of the hereto claims. It is also to be appreciated that the graphics can include any charts or combination of charts, such as, pie graphs, scatter plots, line graphs, etc.

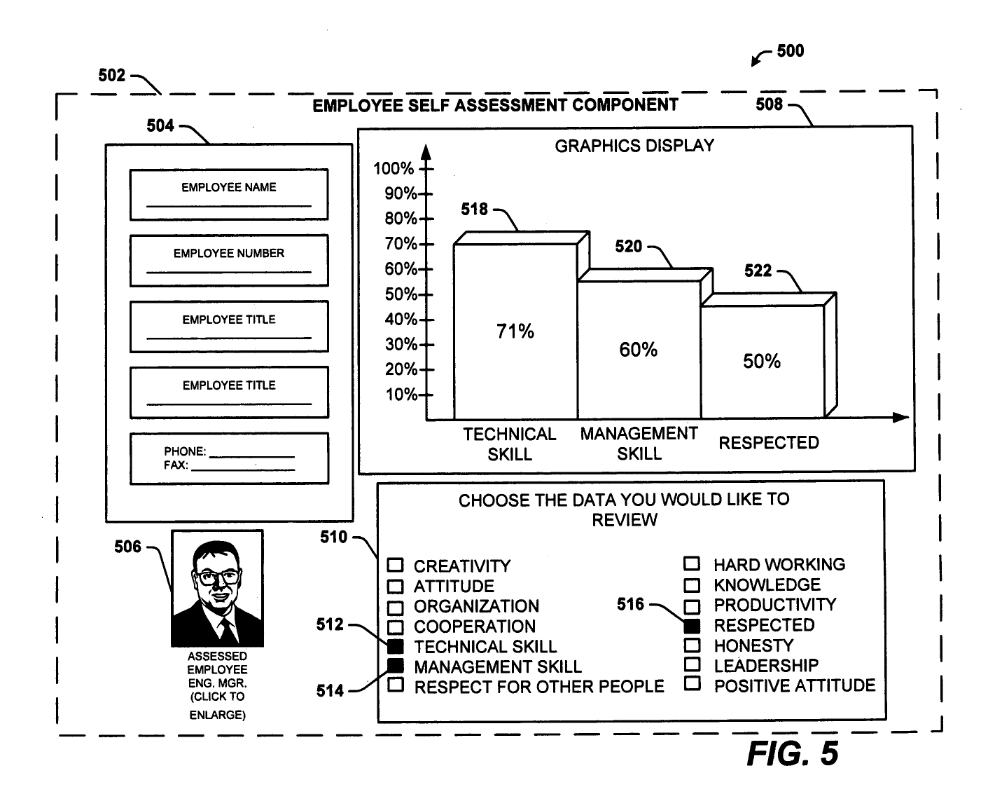

Now referring to FIG. 5, illustrated is an exemplary employee self assessment system 500 in accordance with an aspect of the various embodiments. An employee assessment component 502 can be employed in a business, sales, industrial, manufacturing organization, for example. The employee assessment component 502, can include an identification component 504 and an recognition component 506, similar to the company evaluation system. A graphics display component 508 can display the relationship between chosen characteristics 510. In one example, an employee can be directed to perform a self assessment with the results shown in the graphics display 508 with a technical skill bar 518 of 71%, a management skill bar 520 of 60% and a respected bar 522 of 50%. The numbers can indicate that the currently assessed employee believes that he has higher technical skills than others assessing him in the company. In another example, the currently assessed employee can assess his management skills and respect as average, whereas the company evaluators/assessors might believe that the currently assessed employee has higher rated skills in that area. This can help the employee have a better understanding of others perceptions of himself and can help in matching the CAE to a job that compliments the CAEs set of skills.

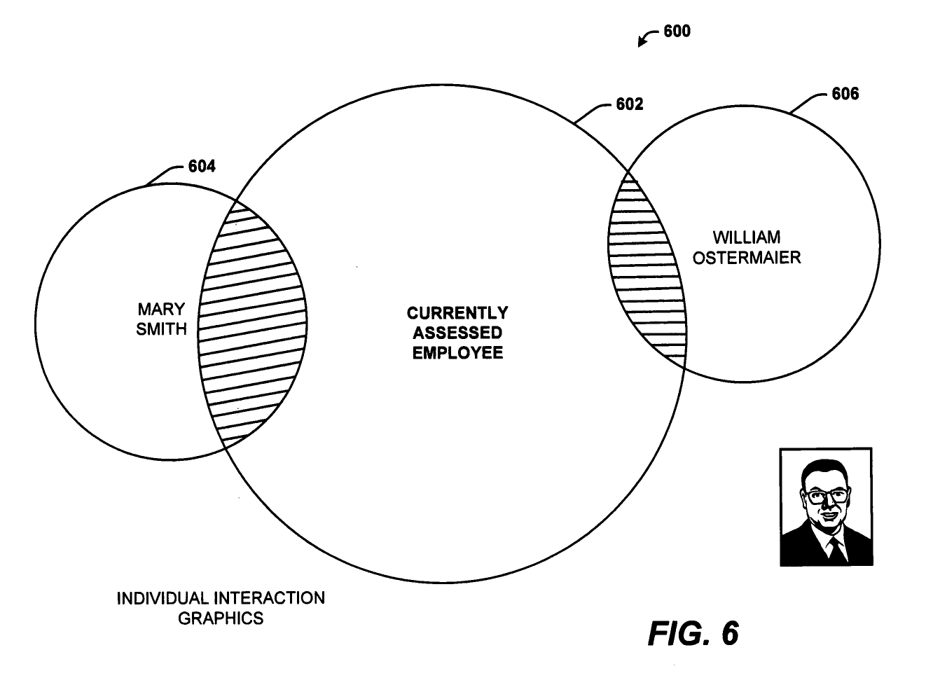

FIG. 6 illustrates an example of an employee evaluation system 600 involving a currently assessed employee 602 and how much the currently assessed employee 602 interacts with other employees, for example, Mary Smith 604 and William Ostermaier 606. An algorithm (weighted average algorithm) can be employed to determine how much weight should be assigned to an individual's assessment of another employee. For example, the shaded intersection of the circles representing the frequency of interaction between currently assessed employee 602 and Mary Smith 604 can visually represent a 32% interaction. Whereas, the intersection between the currently assessed employee 602 and the William Ostermaier 606 represents 19%, for example. These weighted averages can then be employed in the various calculations used to represent various graphs. This can help to eliminate the bias that can be introduced in a 360 degree evaluation and the bias associated with individuals “brown nosing” the manager that does the evaluation but interacts with the CAE very little.

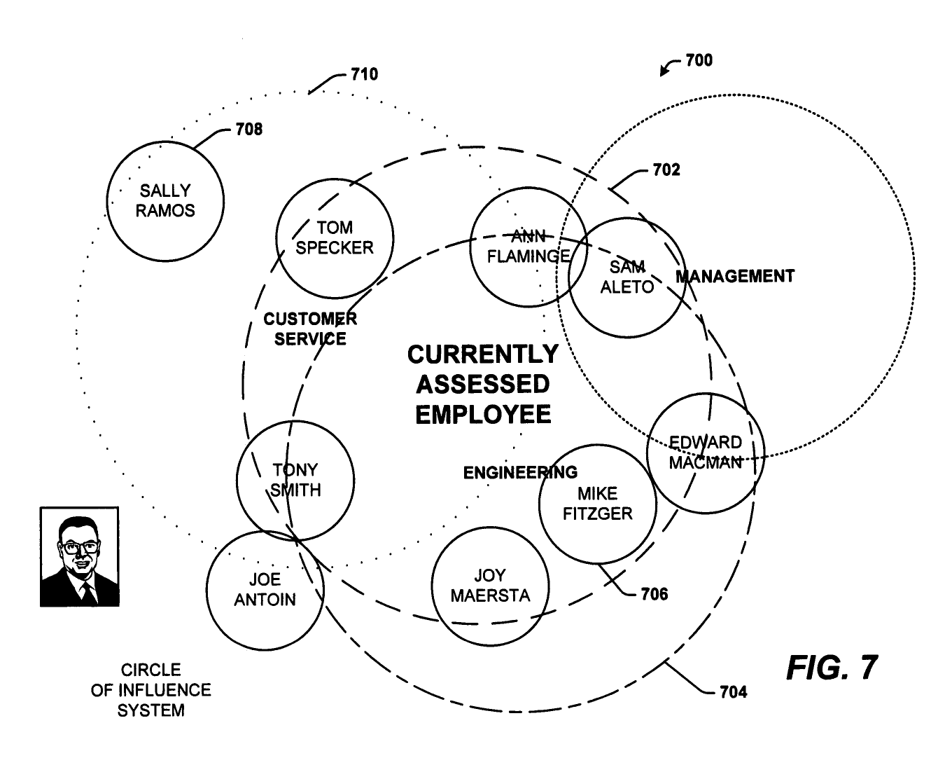

FIG. 7 illustrates an example of a circle of influence system 700. A currently assessed employee circle of influence 702 is illustrated as a darkened dashed circle that indicates how other individuals and business units interact with the currently assessed employee. It should be appreciated that the circle of influence system 700 is provided to facilitate understanding of aspects of the various embodiments and not to limit the scope thereof. As illustrated in FIG. 7, the currently assessed employee, as an engineering manager, interacts heavily with the engineering circle of influence 704. The two intersecting circles show that he has considerable influence or recognition within the engineering group. The CAE circle of influence 702 illustrates that he has much less influence with the management circle of influence 706. It is also clearly illustrated that the currently assessed employee and Sally Ramos 708 in the customer circle of influence 710 do not interact at all. If an employee has limited to no interaction with his co-worker or supervisor, in that the employee works remotely from the main office, then the employees performance can be based upon outcomes and profitability of the employee and not on direct interactions, for example.

With continuing reference to FIG. 7 the circle of influence system 700 can show the potential strength of interaction of the selected employee or business group with respect to, for example, another employee, a business group, a selection of managers, etc. The circle of influence system 700 can be shown as various layers that can be layered one over another. The currently assessed employee circle of influence 702 can be shown as a large circle, centrally located, with the name “Currently Assessed Employee” in the center of the circle. The relation of employees or business groups to the currently assessed employee can be depicted by employing additional circles in relation to the currently assessed employee circle of influence 702. For example, the engineering group circle 704 can be shown arbitrarily as a large dashed circle with a large percentage of the engineering group circle 704 inside the currently assessed employee circle 702 that can indicate that currently assessed employee has a strong interaction with the engineering group. An algorithm within the exemplary system can calculate the interaction strength, for example, on an organization chart, by how much time is spent between currently assessed employee and the engineering group, an interaction grading approach, etc. The interaction strength can be shown, for example, as a bar chart, as a percentage, using shades of color, as a number range, etc.

A strong interaction is illustrated between a Mike Fitzger circle 706 and the currently assessed employee circle 702, by displaying the Mike Fitzger circle 706 completely inside the currently assessed employee circle 702. Thus, Mike Fitzgers assessment or evaluation of the currently assessed employee can be given a heavier weighting because they interact frequently, they are in the same business group, etc. Heavier weightings can be based on other factors such as, strength of interaction, position and level of authority, and the like. Based on the circle of influence system 700, the Sally Ramos circle 708 indicates no interaction by showing the Sally Ramos circle 708 completely outside the currently assessed employee circle 702. Therefore, if Sally Ramos provides input on the CAE's performance she has no experience to base her opinion, clearly a shortcoming with many current evaluation systems.

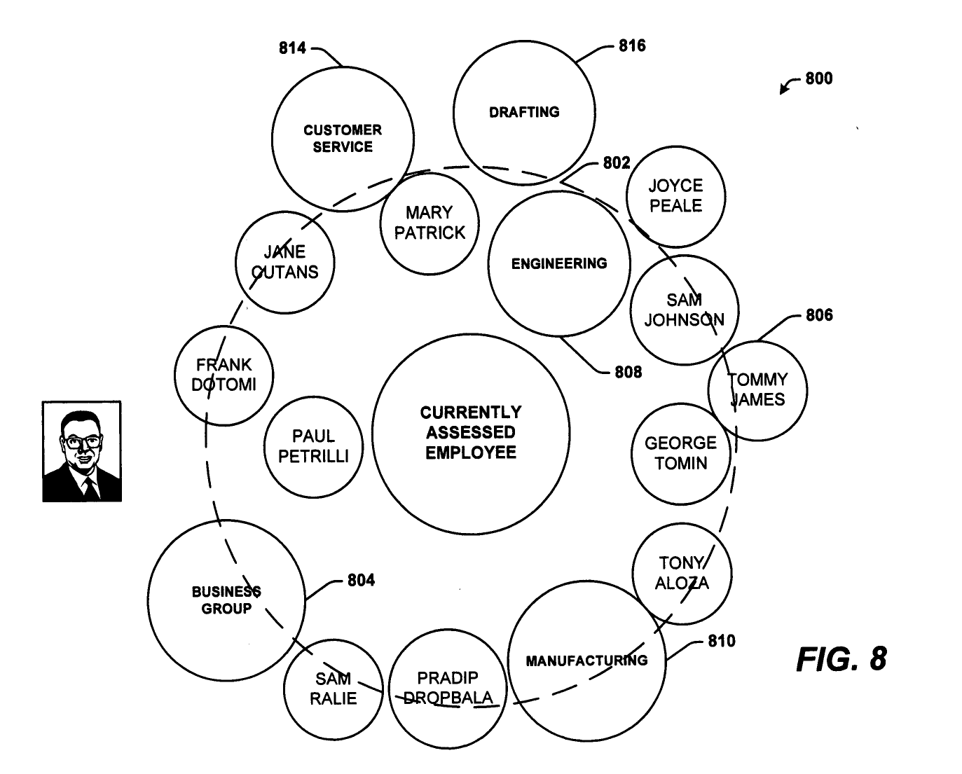

FIG. 8 illustrates an immediate circle of influence system 800 that can be employed in connection with one or more evaluation systems, as illustrated. The immediate circle of influence system 800 can operate in conjunction with an evaluation system to accurately determine the interaction between an currently assessed employee and a business group, an employee, a supplier and two related parties illustrated as a currently assessed employee's circle of influence 802. The system 800 can display anywhere from a single employee to a combination of employees, business-groups, customers, suppliers, consultants, contractors, temporary workers, regulators and the like. The circle of influence system 800 can be constructed by selecting the individuals or groups to display at one time.

According to this embodiment, the currently assessed employee circle of influence 802 can be shown as a large dashed circle, the business group circle 804 can be shown as medium solid line circles, the Tommy James circle 806 can be shown as small solid line circle, etc. with the various circles, except the currently assessed employee circle 802, not overlapping the other circles. The system 800 can provide a visual representation of the strength of interaction between the currently assessed employee 802 and other groups or individuals. For example, the strength of interaction between the assessed employ and either engineering 808, manufacturing 810 or management 812 is stronger than the strength of interaction with either customer service 814 or drafting 816. The strength of interaction can be represented, for example, by line graphs, bar graphs, pie charts, shades of color, etc.

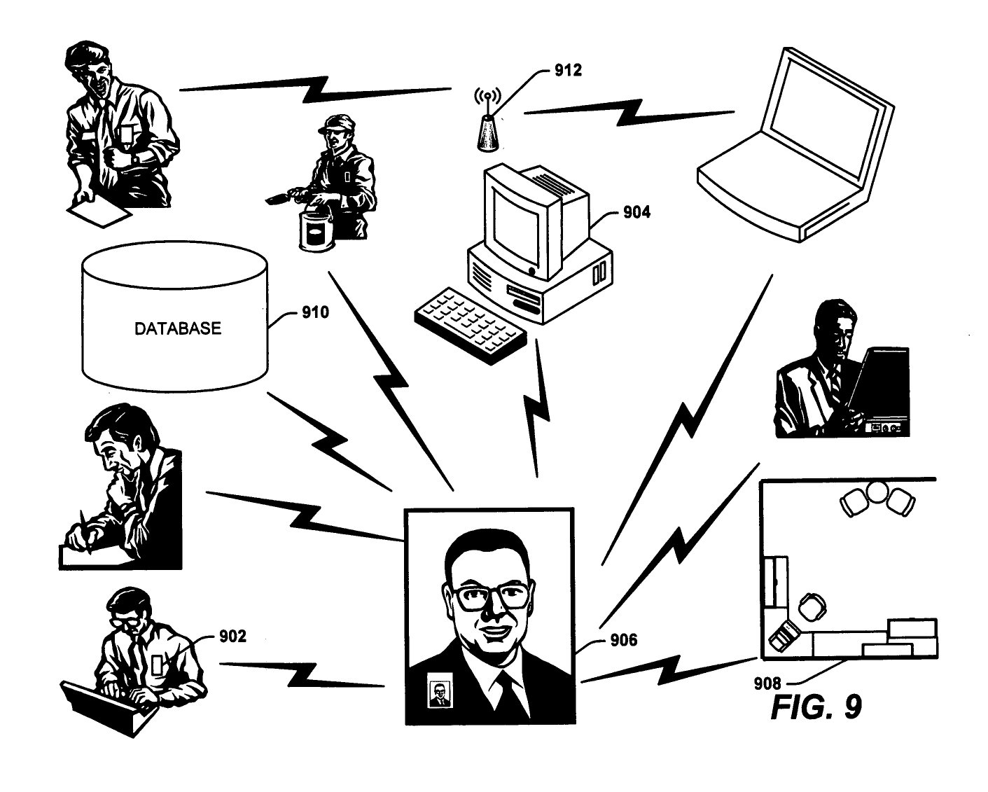

FIG. 9 illustrates an exemplary system 900 that can facilitate generating a wireless relationship among various employees, computers, networks, etc. The various employees can be associated with, for example, individuals wearing RFID badges 902, RFID readers (not shown), etc. According to one aspect of the exemplary system 900 can be employed in connection with one or more evaluation systems as illustrated. The system 900 can employ a computer 904 that can wirelessly communicate to accurately determine how often employees or business groups interact in the system 900. The RFID readers can be located in various key locations within the evaluation system 900 and can range from a single RFID reader to a complex network of RFID readers with, for example, multiple RFID readers, computers 904, databases, etc., integrated together. The RFID badges 902 can be employed to wirelessly collect interaction data when an currently assessed employee 906 enters, for example, an office area 908, an engineering area, a general salesman's office, a manufacturing area, a sales office, a legal department, etc., that can be stored in a database 910. The data can be transferred utilizing a variety of mediums, hard-wire, the Internet, a hard-wire network connection, wireless, infra-red, Blue-tooth, ultra-wide band, satellite, etc. A wireless access point 912 can be utilized to transfer data throughout a building. Those individuals that work remotely would use the same application utilizing GPS technology rather than the RFID system. Utilization of GPS would track the employees travel and daily productivity outside of their office location in areas that were monitored by RFID. The rationale behind the use of the GPS system would indicate that the more productive the employee, the more likely the employee would realize increased revenue production for the company, consequently a more positive evaluation outcome.

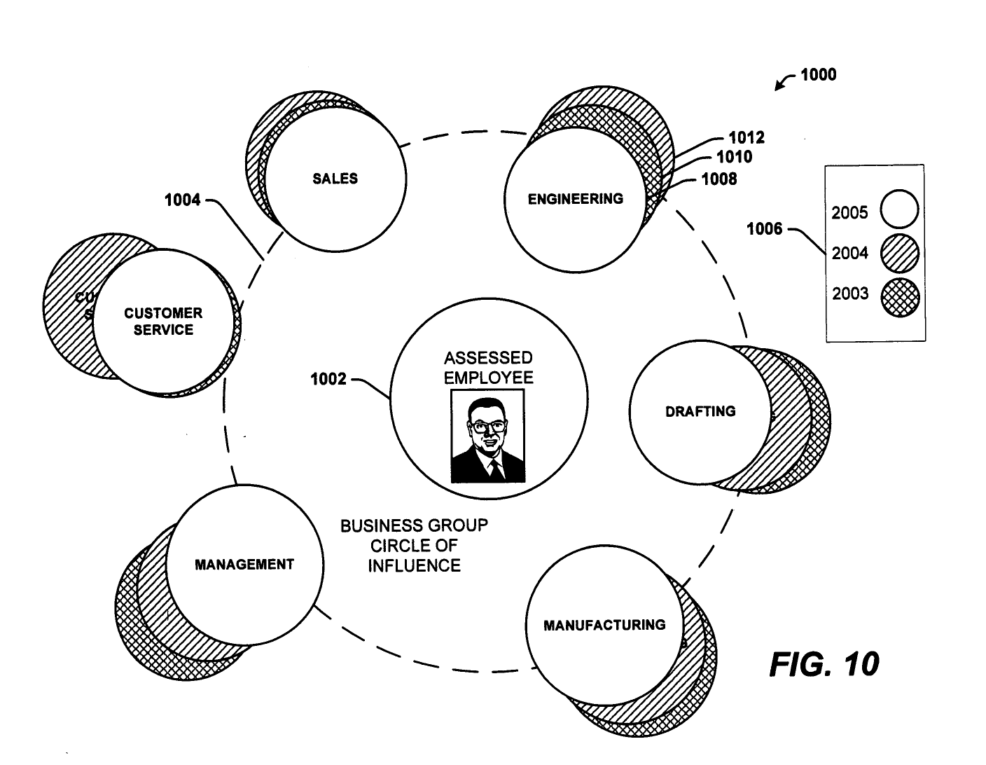

FIG. 10 illustrates a system 1000 that can facilitate the displaying of business group employee assessments year over year. A currently assessed employee 1002 can have an associated business group circle of influence 1004 that can allow authorized personnel to interpret or review how the currently assessed employee's relationship with various business groups changes year over year. The business group circle of influence 1004 can be represented by the large dashed circle in FIG. 10 and the business group interaction strength with the currently assessed employee 1002 can be represented by business group circles and their spatial relation to the larger circle. A larger interaction can be represented by a business group circle being further inside the business group circle of influence 1004. The index 1006 can be displayed as a rectangle with differentiated circles and associated years, the circles can be, for example, colored, shaded with various patterns, numbered, and the like to represent the evaluation year for the various business groups. For example, a “2005 engineering circle” 1008 can indicate a better evaluation in 2005 than in 2004 where the “2005 engineering circle” 1008 is further inside the business group circle of influence 1004 than the “2004 engineering circle” 1010. The “2003 engineering circle” 1012 is shown in FIG. 10 as being further inside the business group circle of influence 1004 than the “2004 engineering circle” 1010 which can indicate that the currently assessed employee 1002 interaction strength is lower in 2004 than 2003. The interaction strength can be defined by the company based on, for example, respect for others, ability to communicate, sales numbers, number of contacts made, reports completed, management skill, negotiation skills, creativity, number of contacts made, time spent with various business groups, customer service, and the like.

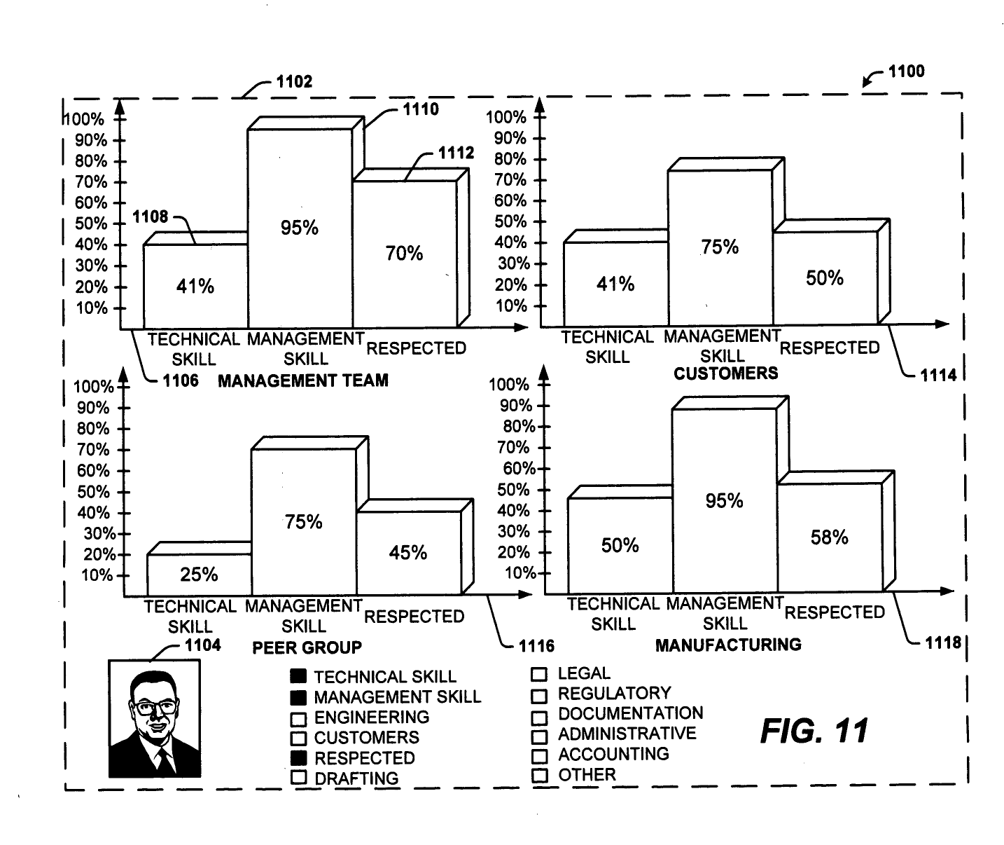

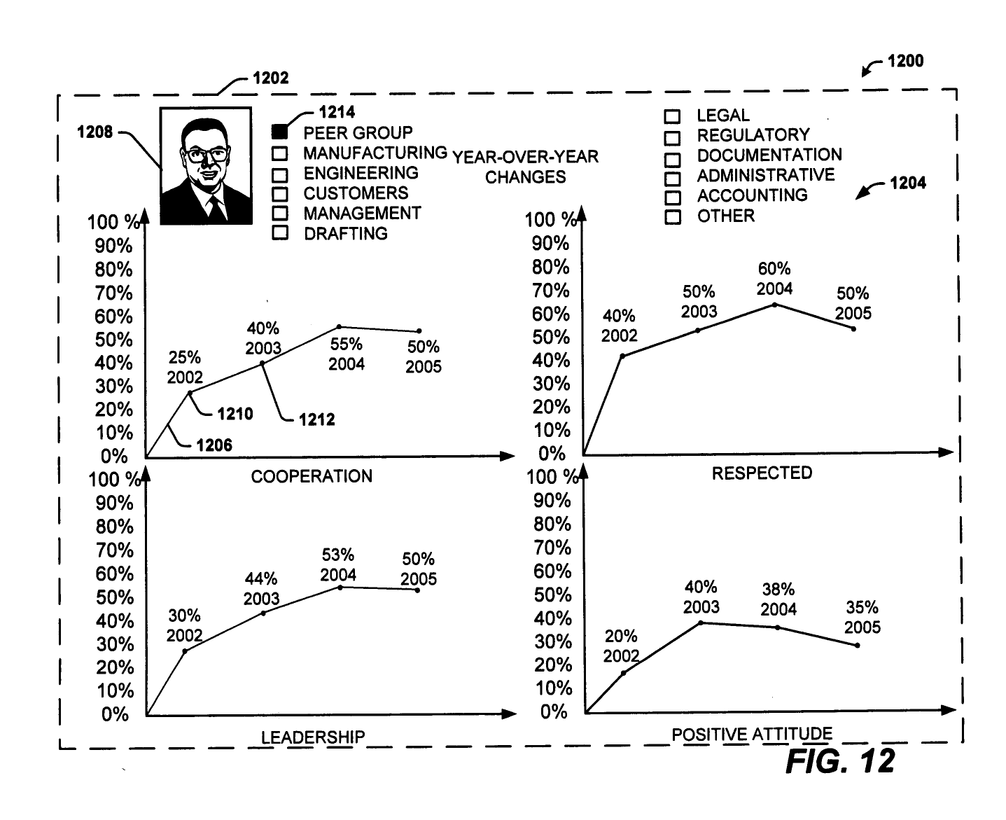

Referring now to FIG. 11, an employee assessment system 1100 for employment within an evaluation system is illustrated. The employee assessment system 1100 can incorporate a business group assessment component 1102 that can display an currently assessed employee's 1104 business group's evaluation of various characteristics, for example, sales ability, attitude, technical ability, management skill, respect, ability to communicate, respect for others, creativity, etc. For example, a currently assessed employee 1104 can be evaluated by a management team 1106 that can evaluate various characteristics for the currently assessed employee 1104. The specific evaluation characteristics that an employee will be evaluated on can be determined by the company, can vary business group to business group, year after year, level to level, etc., as well as weighting factors that can be associated with individuals involved in the various evaluations. In yet another example, the management team 1006 can provide a technical skill rating 1108 of 41%, a management skill rating 1110 of 95%, a respected rating 1112 of 70%, etc. which an authorized employee can view by selecting those characteristics. The authorized user can also select the year that the characteristics were evaluated; the business group, employee, supplier, consultant, recruiter, etc., performing the evaluation; the way the characteristic ratings are displayed; etc.

Referring now to FIG. 1200, a performance evaluation system 1200 that can be employed in work environment is illustrated to aid in recognizing a currently assessed employee's performance during a given performance period. A characteristic assessment component 1202 is typically made up of a display component 1204 that can be e.g., a computer, a iPod, a PDA, etc. For example, the display component 1204 can be employed to exhibit a line graph 1206. More particularly, the currently assessed employee's 1210, “2002 cooperation rating” 1210 can be determined to be 25%, in other words employees, suppliers, business groups, etc., evaluated, based on a 100% scale. The “2002 cooperation rating” 1212 can show an increase 40% and might indicate that the currently assessed employee has shown increased cooperation with other employees, business groups, suppliers, etc. The system 1200 can compare parties that contributed to the evaluation, weighting factors, etc., to other evaluation years. The employee, partner, owner, etc., authorized to review the data can select which characteristics of the assessed employ to review, what years to review, how to display the data, etc.

In one particular example, characteristics stored in a database (not show) can be removed if the employee has been fired, the employee quit, the employee joined another business group, the employee retired, etc. It is to be appreciated that the algorithm can organize software and/or data bases, for example, based on data age, frequency of access, relationship to other data, priority of data, user preference, file size, amount of available space, etc. Evaluating employees accurately makes the employees more valuable to all parties, e.g., the company, business groups and customers. Data can be transferred from a database to a browsing device within the performance evaluation system 1200. The delivery resource can be a resource provider, such as the Internet, a cell tower, an external store, etc. For instance, the authorized individual can be stored in the memory of a disk, DVD, memory card, etc. It is to be appreciated that the data described supra can contain and/or include any combination of digital data, such web-page data, software programs, photographs, video, query logs, etc.

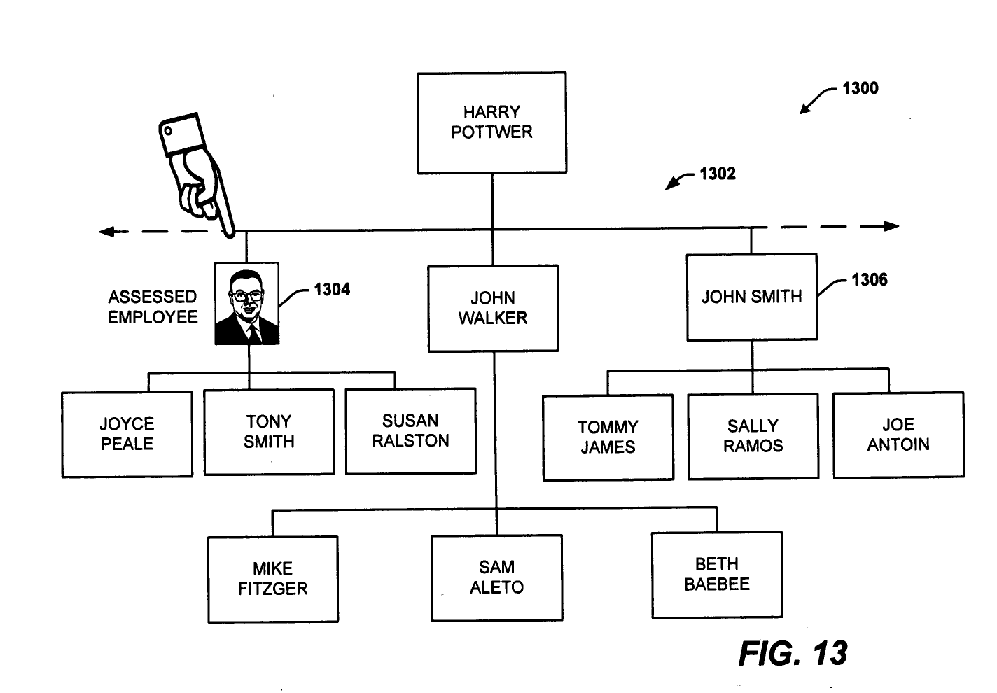

Turning now to FIG. 13, yet another employee evaluation system 1300 that accords to the claimed subject matter is illustrated. The employee evaluation system 1300 employs an organization chart 1302, which can be associated with a currently assessed employee 1304 and the safety audit database. An external database can be associated with several of the organization charts 1302 that can aid gathering employee data and storing that data. An authorized employee can select various employees within the organization chart to view their various evaluations and pertinent information, such as, identifying photograph, title, evaluation data, etc.

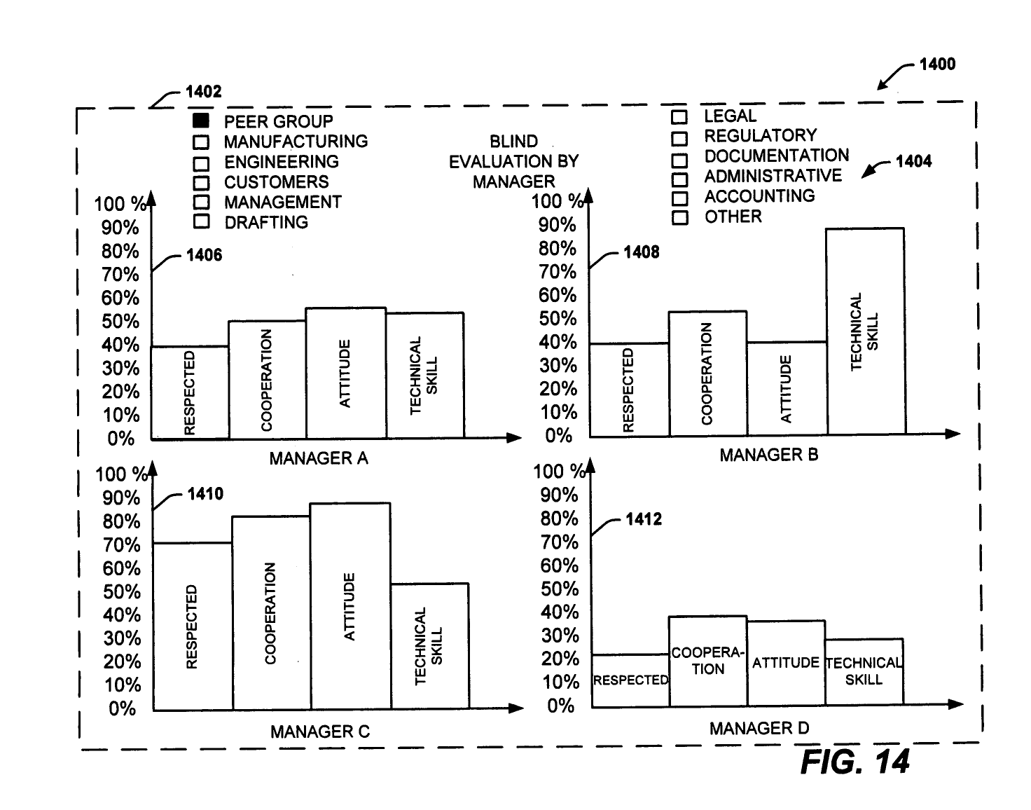

FIG. 14 illustrates a “blind” employee evaluation system 1400 that facilitates evaluating employees in relation to each other. A characteristic evaluation component 1402 can employ a display component 1404 that facilitates presentation of various employees. It is to be appreciated that the display component 1404 can be a laptop computer, a PDA, cellular automata, programmable computing devices (PCD), mobile phones, etc. The characteristic evaluation component 1402 can be any suitable device associated with an algorithm and/or process, wherein the characteristic evaluation component 1402 can communicate with the authorized individual. In one example, the authorized individual can compare the various employees without revealing their names just comparing only characteristics. This can allow the authorized individual to compare the employees with less bias by not knowing the currently assessed employee's names.

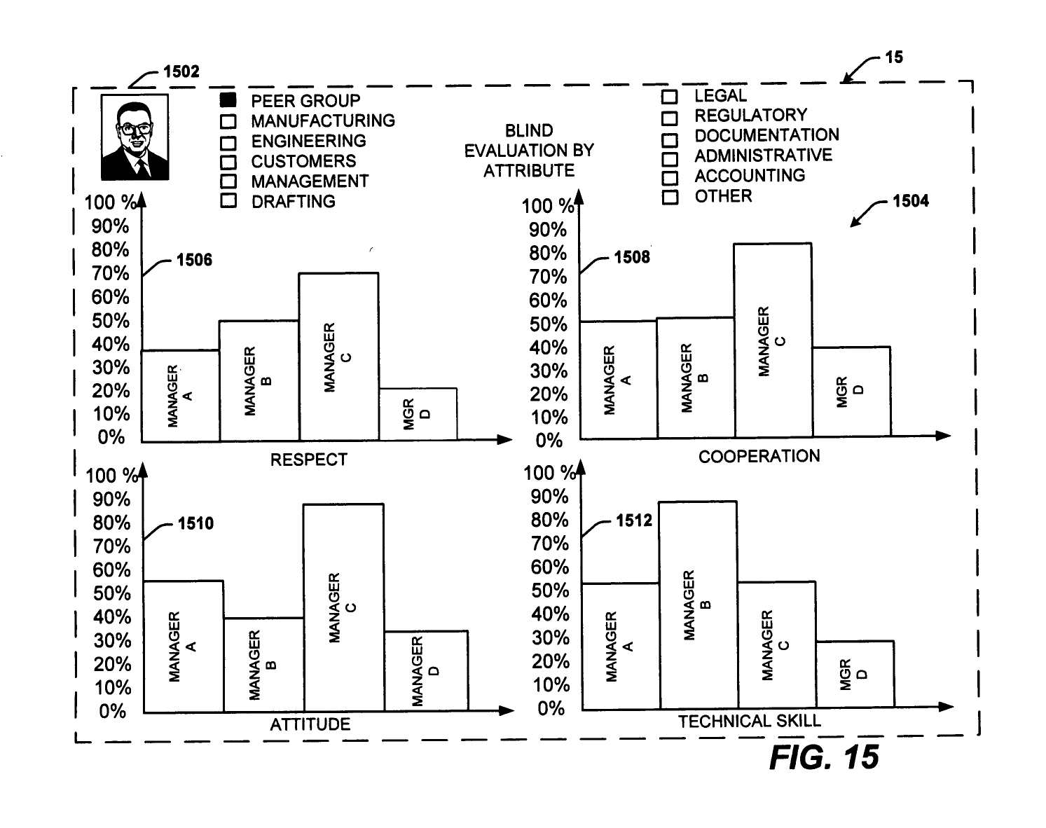

Now referring to FIG. 15, an employee evaluation system 1500 for use in an industrial, manufacturing, sales, marketing, etc., environment is illustrated. The employee evaluation system 1500 utilizes a currently assessed employee characteristic component 1502 and a characteristic display component 1504, which is employed to display characteristic data. For those employees that predominately interface with customers outside of the workplace, a questioner could be sent to the customer to rate the employee on various facets of service delivery to the customer; i.e., does the employee interface with the customer on a regular basis, respond to customer questions comprehensively and in a time efficient manner, are errors handled efficiently and is resolution realized. A compilation of responses would then be entered in the employee data evaluation system 1500 by an HR representative, for example

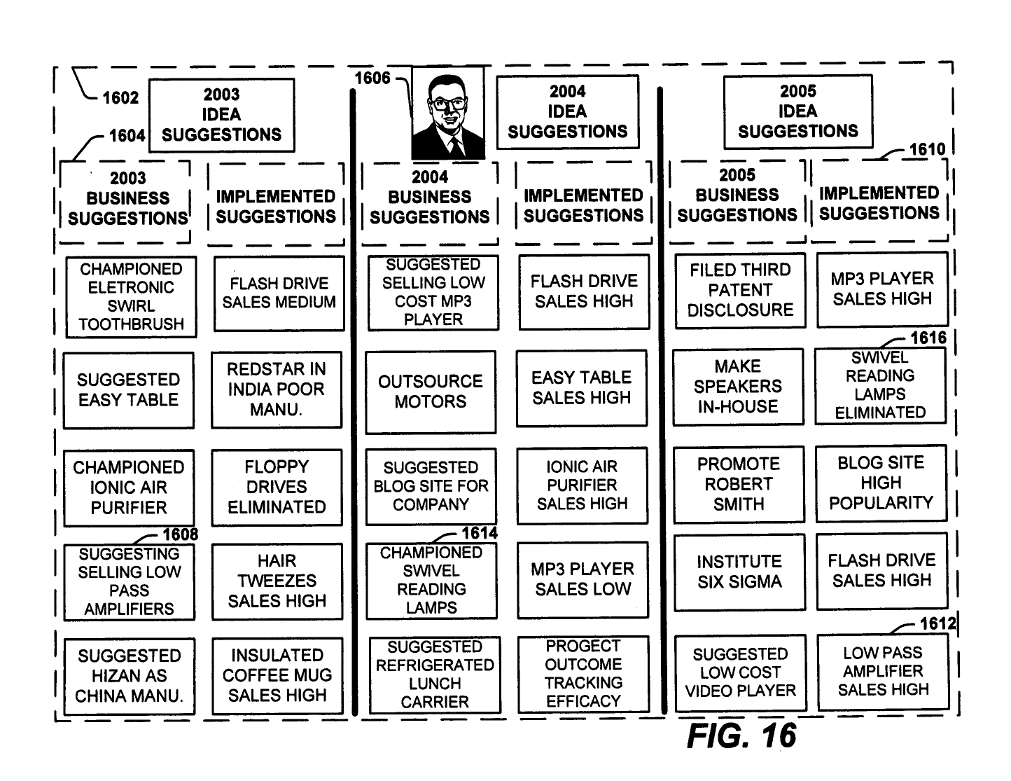

FIG. 16 illustrates an employee idea tracking system 1600 that facilitates analyzing employee ideas in accordance with an aspect of the present invention. An idea analysis component 1602 can be utilized to analyze the currently assessed employee's business ideas to determine the values of the ideas. In one example, a “2003 business suggestion” 1604 by the currently assessed employee 1606 can be suggesting a low pass amplifiers 1608. In 2005 the CAE implemented suggestion 1610 indicates low pass amplifier sales high 1612, which can indicate that the employee suggested an idea that resulted in high sales and has helped the business move forward. The success or value of the idea can be graded based on, for example, sales, generated profit, etc. A total score can be generated for all the ideas, e.g., suggested, championed, rejected, etc., in order to determine the CAE contribution to ideas in the business. In this way individuals with high scores can be placed in positions to help the business generate ideas, new products, plan business strategy, etc.

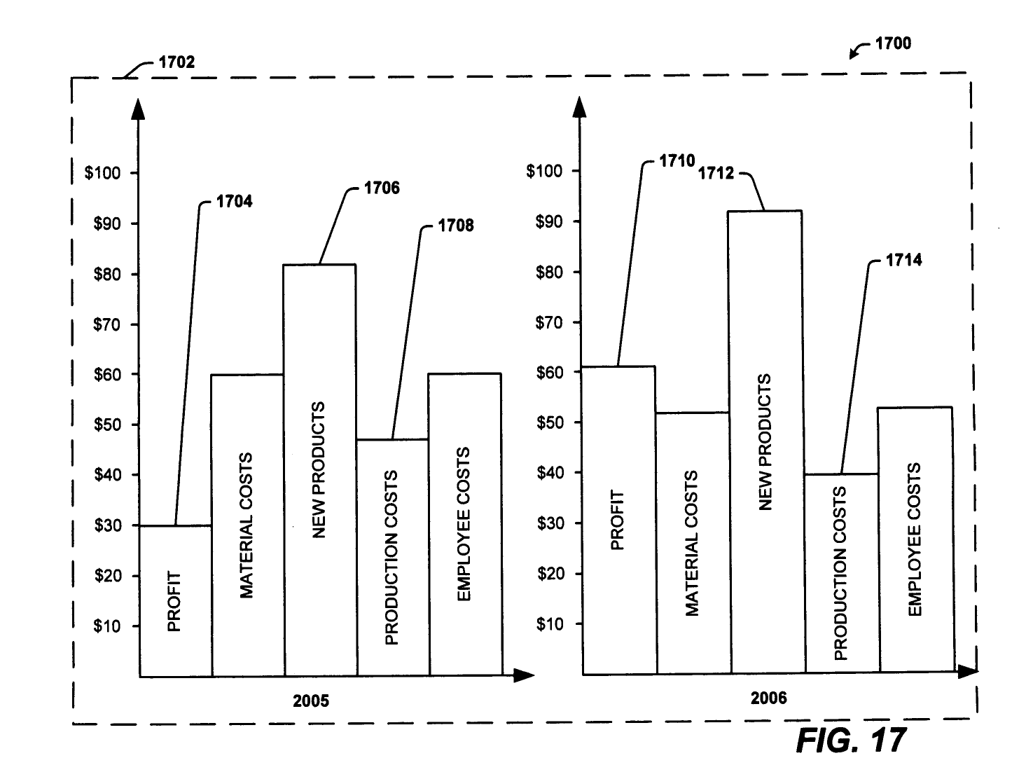

Referring now to FIG. 17, an employee evaluation system 1700 can be employed in connection with one or more company performance systems is illustrated. The employee evaluation system 1700 utilizes a company performance attribute display component 1702 that is typically made up of performance attributes that can be displayed graphically. The system 1700 can utilize an algorithm to determine percentages, changes in performance attributes year over year, whether company goals were reached, what business changes effected those performance attributes, and the like. Profit 1704 data stored in a database can be accessed by authorized individuals to determine the profit that is made each year. The algorithm can be utilized to determine, for example, the amount of profit 1704 per year as a correlation to the number of new products 1706 introduced that year, as a function of the number of new customers, etc. It is to be appreciated that the database can optionally include various data (including promotions, bonuses, stock options, sales, profit, sales contacts, marketing numbers, tooling costs, production numbers, etc.

In one example, “2005 profit” 1704 of 10 million dollars can increase to a “2006 profit” of 15 million dollars, or a 50% increase in profits from 2005 until 2006. An algorithm can correlate the increase in profits to a 30% increase in new products, increased sales of seven products, outsourcing four products, and the like. The “2005 sales” 1710 can be $82 million, whereas the “2006 sales” 1712 are $91 million, in other words, an increase of 9.9% from 2005 to 2006. “2005 production costs” 1716 were reduced “2006 production costs” 1718 going from $47 million to $39 million.

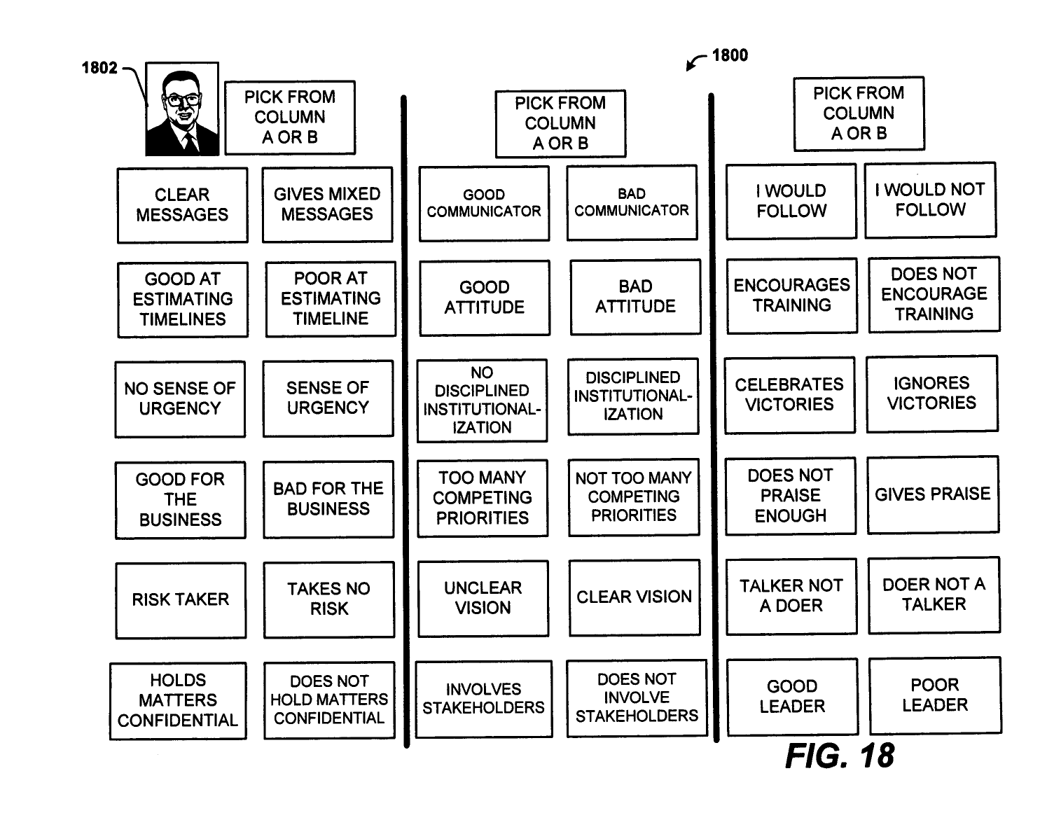

FIG. 18 illustrates yet another employee evaluation system 1800 that is in accordance with the claimed subject matter. The individual or business group can perform a high/low evaluation annually, semi-annually or on a periodic basis. The individuals can be, for example, consultants, suppliers, employees, contractors, administrators, customers, mechanics, advisors, sales reps, and the like. The business groups can be sales group, a marketing group, a regulatory group, legal, etc. The evaluator can quickly select from a list characteristics, so that a currently evaluated employee 1802 can be provided with feedback on a frequent basis, for example, quarterly. The CAE 1802 can be evaluated based characteristics that the company defines as critical, such as risk taking, for example. The CAE 1802 can be evaluated by the individuals or the business groups that the company deems as critical to evaluation process.

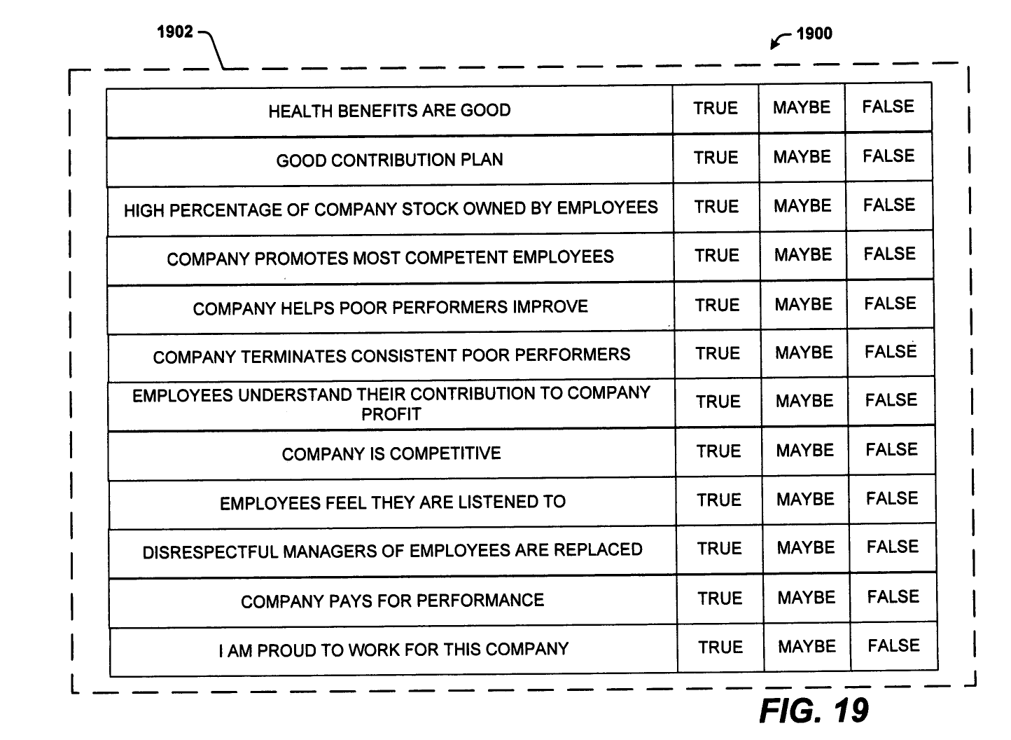

FIG. 19 illustrates a company evaluation system 1900 in accordance with various aspects of the claimed subject matter. Employees within the organization can evaluate the company based key characteristics in order to determine how the company is performing. For example, the employees can determine whether they feel the employee health benefits are good. The employees can, for example, rank the health benefits on a scale of 1 to 100, pick yes, maybe or no, and the like. The company can determine from employee feedback, for example, whether the company promotes the right people, whether employees are proud to work for the company, whether the company terminates poor performers, etc. The company can show the results to the employee, keep the results private, share selected results, etc. The characteristics can be evaluated year over year in order to improve the company's performance and in order to determine whether the company's performance is improving. This can lead to improved employee performance, better morale, lower turnover, etc.

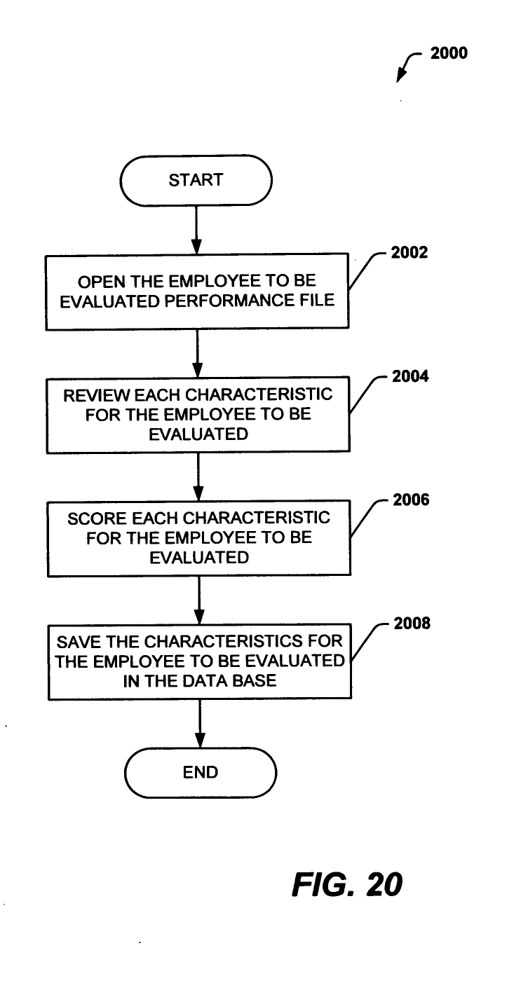

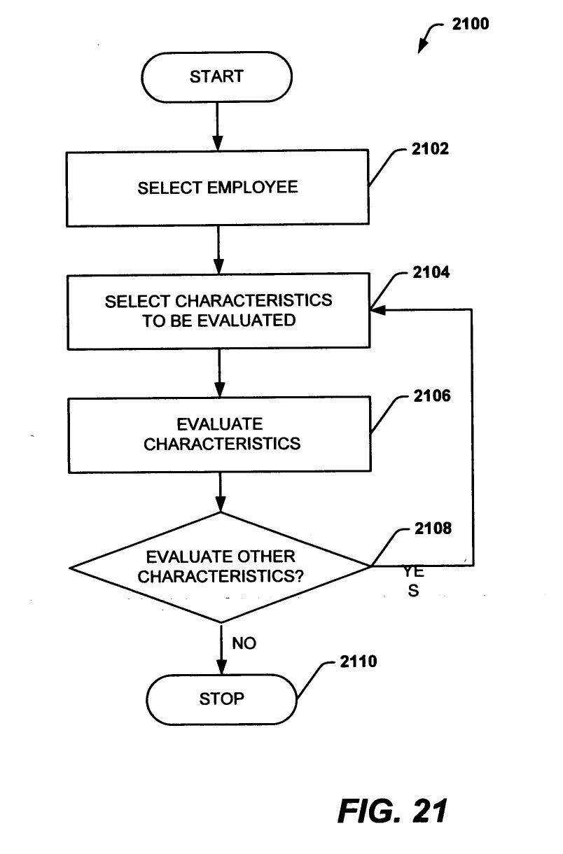

FIGS. 20-21 illustrate methodologies in accordance with various embodiments of the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 20 illustrates an embodiment of an aspect. The system 2000 can be utilized to evaluate a currently assessed employee with respect to various characteristics, such as, respect for others, technical skills, sales ability, management skill, etc. In the event that the currently assessed employee does not have a good relationship with other employees, human resources can look for ways to improve that relationship if it is deemed vital to the company. In yet another example, say legal counsel is being evaluated and has a great relationship with upper level management and yet bullies and intimidates others at lower levels. This type of behavior will be captured in the evaluation.

The method starts at 2002 where the currently assessed employee's evaluation file is opened. This can be required because the evaluation file can correspond to year over year evaluations. At 2004, each characteristic of the currently assessed employee is evaluated, for example, with respect to previous years, other employees, etc. At 2006 a score for each employee characteristic is calculated, for example, a scale of 1 to 10, a 100% scale, grades A, B, C, etc. At 2008 the characteristic scores are loaded in a database and can be retrieved when necessary.

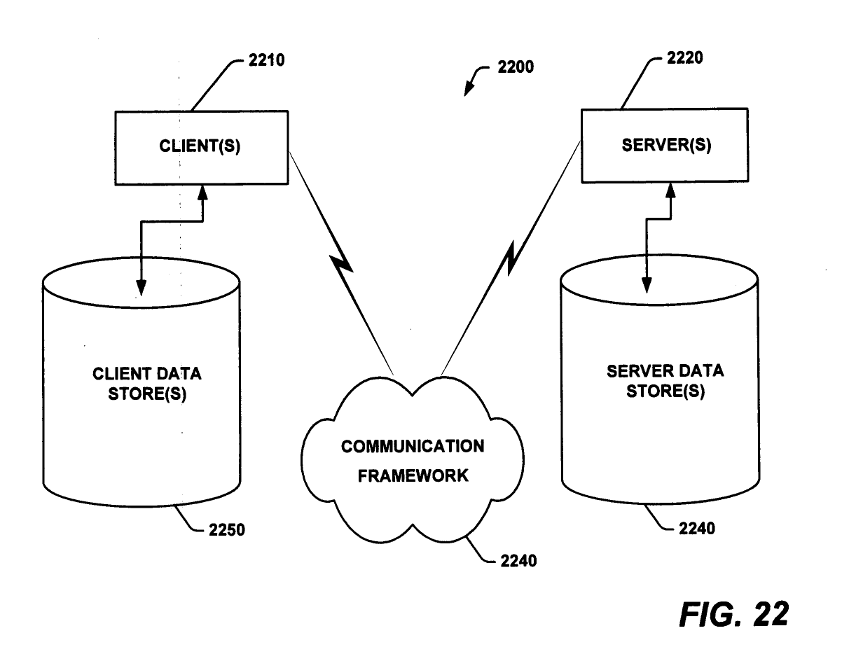

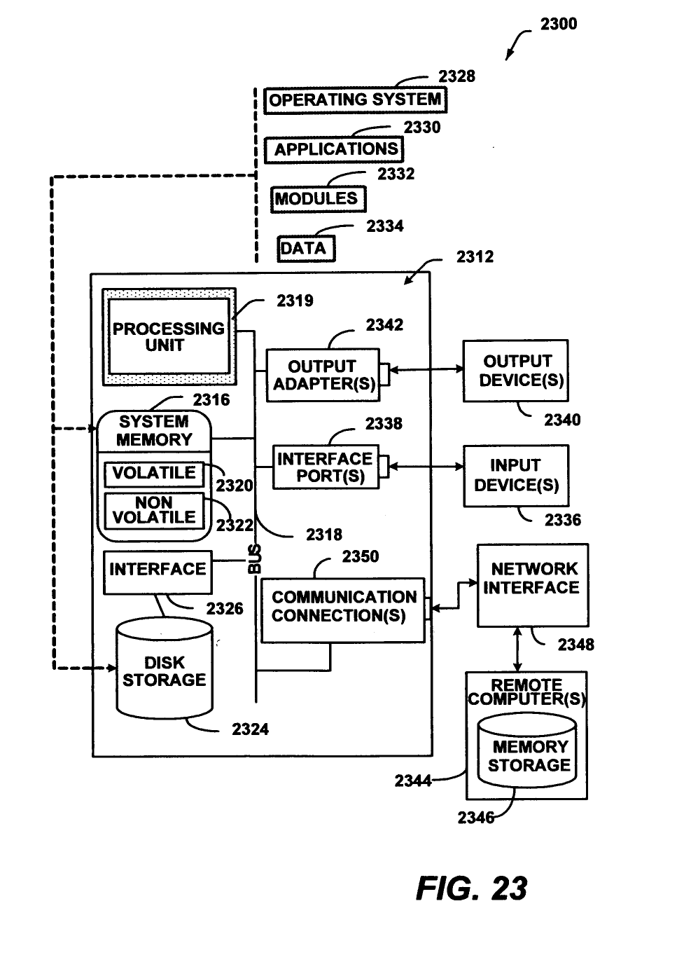

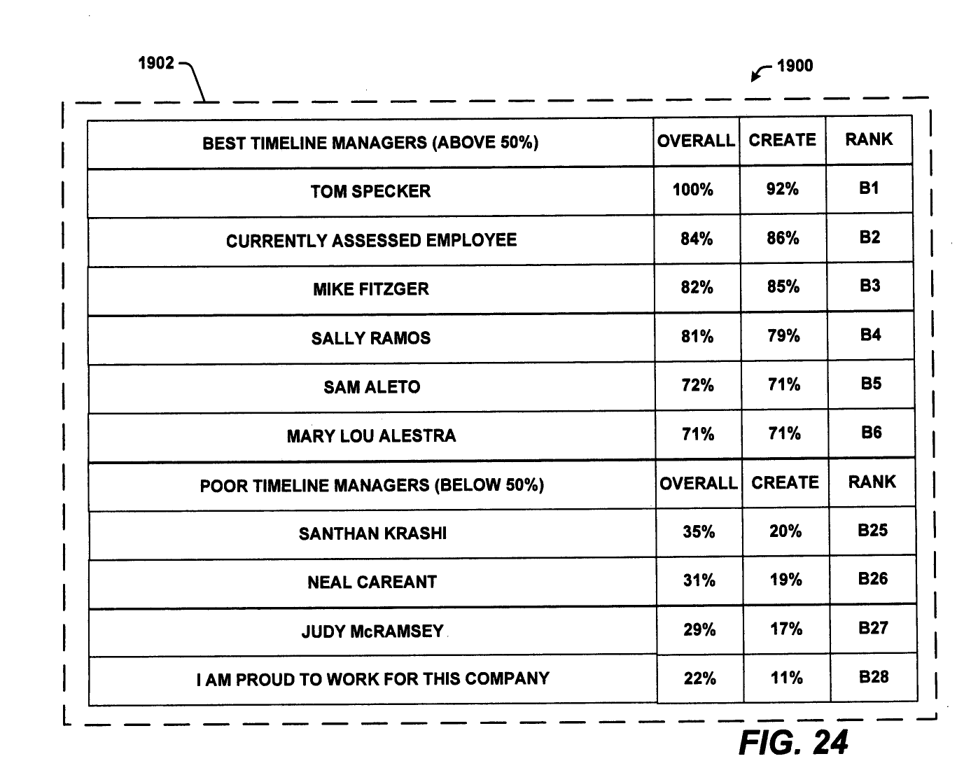

FIGS. 22 and 23 and the following discussion is intended to provide a brief, general description of a suitable computing environment in which the various aspects disclosed herein may be implemented. While the embodiments have been described above in the general context of computer-executable instructions of a computer program that runs on a local computer and/or remote computer, those skilled in the art will recognize that the embodiments also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects may also be practiced in distributed computing environments where certain tasks are performed by remote processing devices that are linked through a communications network. However, some, if not all, aspects of the embodiments may be practiced on stand-alone computers. In a distributed computing environment, program modules may be located in local and/or remote memory storage devices.

FIG. 22 is a schematic block diagram of a sample-computing environment 2200 with which the various embodiments can interact. The system 2200 includes one or more client(s) 2210. The client(s) 2210 can be hardware and/or software (e.g., threads, processes, computing devices). The system 2200 also includes one or more server(s) 2220. The server(s) 2220 can be hardware and/or software (e.g., threads, processes, computing devices). The servers 2220 can house threads to perform transformations by employing one or more embodiment, for example.

One possible communication between a client 2210 and a server 2220 can be in the form of a data packet adapted to be transmitted between two or more computer processes. The system 2200 includes a communication framework 2240 that can be employed to facilitate communications between the client(s) 2210 and the server(s) 2220. The client(s) 2210 are operably connected to one or more client data store(s) 2250 that can be employed to store information local to the client(s) 2210. Similarly, the server(s) 2220 are operably connected to one or more server data store(s) 2230 that can be employed to store information local to the servers 2240.

With reference to FIG. 23, an exemplary environment 2300 for implementing various aspects disclosed herein includes a computer 2312. The computer 2312 includes a processing unit 2314, a system memory 2316, and a system bus 2318. The system bus 2318 couples system components including, but not limited to, the system memory 2316 to the processing unit 2314. The processing unit 2314 can be any of various available processors. Dual microprocessors and other multiprocessor architectures also can be employed as the processing unit 2314.

The system bus 2318 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 2294), and Small Computer Systems Interface (SCSI).

The system memory 2316 includes volatile memory 2320 and nonvolatile memory 2322. The basic input/output system (BIOS), containing the basic routines to transfer information between elements within the computer 2312, such as during start-up, is stored in nonvolatile memory 2322. By way of illustration, and not limitation, nonvolatile memory 2322 can include read only memory (ROM), programmable ROM (PROM), electrically programmable ROM (EPROM), electrically erasable ROM (EEPROM), or flash memory. Volatile memory 2320 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 2312 also includes removable/non-removable, volatile/non-volatile computer storage media. FIG. 23 illustrates, for example a disk storage 2324. Disk storage 2324 includes, but is not limited to, devices like a magnetic disk drive, floppy disk drive, tape drive, Jaz drive, Zip drive, LS-130 drive, flash memory card, or memory stick. In addition, disk storage 2324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 2324 to the system bus 2318, a removable or non-removable interface is typically used such as interface 2326.

It is to be appreciated that FIG. 23 describes software that acts as an intermediary between users and the basic computer resources described in the suitable operating environment 2330. Such software includes an operating system 2328. Operating system 2328, which can be stored on disk storage 2324, acts to control and allocate resources of the computer system 2312. System applications 2330 take advantage of the management of resources by operating system 2328 through program modules 2332 and program data 2334 stored either in system memory 2316 or on disk storage 2324. It is to be appreciated that the various embodiments can be implemented with various operating systems or combinations of operating systems.

A user enters commands or information into the computer 2312 through input device(s) 2336. Input devices 2336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 2314 through the system bus 2318 through interface port(s) 2338. Interface port(s) 2338 include, for example, a serial port, a parallel port, a game port, and a universal serial bus (USB). Output device(s) 2340 use some of the same type of ports as input device(s) 2336. Thus, for example, a USB port may be used to provide input to computer 2312, and to output information from computer 2312 to an output device 2340. Output adapter 2342 is provided to illustrate that there are some output devices 2340 like monitors, speakers, and printers, among other output devices 2340, which require special adapters. The output adapters 2342 include, by way of illustration and not limitation, video and sound cards that provide a means of connection between the output device 2340 and the system bus 2318. It should be noted that other devices and/or systems of devices provide both input and output capabilities such as remote computer(s) 2344.

Computer 2312 can operate in a networked environment using logical connections to one or more remote computers, such as remote computer(s) 2344. The remote computer(s) 2344 can be a personal computer, a server, a router, a network PC, a workstation, a microprocessor based appliance, a peer device or other common network node and the like, and typically includes many or all of the elements described relative to computer 2312. For purposes of brevity, only a memory storage device 2346 is illustrated with remote computer(s) 2344. Remote computer(s) 2344 is logically connected to computer 2312 through a network interface 2348 and then physically connected by communication connection 2350. Network interface 2348 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 2350 refers to the hardware/software employed to connect the network interface 2348 to the bus 2318. While communication connection 2350 is shown for illustrative clarity inside computer 2312, it can also be external to computer 2312. The hardware/software necessary for connection to the network interface 2348 includes, for exemplary purposes only, internal and external technologies such as, modems including regular telephone grade modems, cable modems and DSL modems, ISDN adapters, and Ethernet cards.

What has been described above includes examples of the various embodiments. It is, of course, not possible to describe every conceivable combination of components or methodologies for purposes of describing the embodiments, but one of ordinary skill in the art may recognize that many further combinations and permutations of the various embodiments are possible. Accordingly, the detailed description and attached appendices are intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the various embodiments. In this regard, it will also be recognized that the one or more embodiments includes a system as well as a computer-readable medium having computer-executable instructions for performing the acts and/or events of the various methods of the embodiments.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A business profit and resource optimization system that calculates an employee evaluation, comprising:
an input component that is utilized to input assessment data related to characteristics for a currently assessed employee utilizing the assessment data from a plurality of evaluators;
an idea component that analyzes ideas of the currently assessed employee in terms of idea success year over year; and
a display component that interacts with the input component and allows viewing of an employees evaluation.

2. The system of claim 1, wherein the plurality of evaluators comprises: a co-worker, a sales person, an engineer, a customer, an employee, a regulatory representative, a legal representative, a researcher, a manager, a marketing person, a key employee, a consultant, a contractor, a supervisor, a supplier and a business group.

3. The system of claim 1, wherein the characteristics comprise at least one of the following: accountability, adaptability, attendance, attitude, cooperation, creativeness, dependability, honesty, human relations, idea generation, idea success, idea failure, initiative, intelligence, interpersonal relationships, judgment, leadership, management skill, organization, planning, presentation ability, punctuality, quantity of work, quality of work, reliability, respect for others, and teamwork.

4. The system of claim 1, wherein the evaluation of the currently assessed employee is based on at least one of the following: ideas proposed by the currently assessed employee in present evaluation period and past years of employment, ideas submitted by the currently assessed employee in the present evaluation period and the past years of employment, ideas submitted by the currently assessed employee as patent disclosures in the present evaluation period and past years of employment, ideas championed by the currently assessed employee in the present evaluation period and the past years of employment, the currently assessed employee rejected ideas rated according to a scaling factor in the present evaluation period and the past years of employment, and the currently assessed employee's accepted ideas rated according to a scaling factor in the present evaluation period and the past years of employment.

5. The system of claim 4, wherein the scaling factor comprises at least one of the following: revenue generated by the idea, the rated success of the idea, whether the idea was acted upon, whether the idea worked, whether the idea failed and whether the idea was patented.

6. The system of claim 1, wherein the input component further comprises an employee self-assessment component that allows the currently assessed employee to self evaluate his performance.

7. The system of claim 1, wherein the input component further comprises a company assessment component that provides a performance evaluation of the currently assessed employee.

8. The system of claim 1, wherein the input component reminds the plurality of evaluators to enter periodic data with regard to the currently assessed employee, wherein the period comprises at least one of the following: daily, weekly, monthly, quarterly and yearly.

9. The system of claim 1, wherein a communication component further includes an employee compensation component that allows the currently assessed employee to understand currently assessed employee's total compensation.

10. The system of claim 1, wherein the communication component further allows authorized employees to view the currently assessed employee and/or a currently assessed entity in relation to another entity, wherein the currently assessed entity and/or the another entity comprise; organization(s), employee(s), colleague(s), business group(s), progress plan(s), interaction frequency, prior evaluation (s), idea(s) and profit(s).

12. The system of claim 1, wherein an interaction component determines the interaction frequency between the currently assessed employee and the plurality of evaluators.

13. The system of claim 12, wherein the interaction component comprises an RFID badge, an RFID reader, a smart card, a smart card reader, a bar code badge and a bar code reader.

14. An employee idea tracking system that facilitates analyzing company ideas, comprising:
an idea analysis component that is utilized to input and store a current assessed employee ideas on a periodic basis during the length of the employees employment;
wherein idea analysis component determines the value of the employee ideas; and
an annualized score is assigned to the current assessed employee based upon the value of the employee ideas that is part of an annual evaluation.

15. The system of claim 14, wherein the value of the employee's ideas comprises sales generated from the employee's ideas, profits generated from the employee's ideas, sales generated from the employee's ideas, patents filed based upon the employees ideas, championing someone else's successful ideas, championing someone else's unsuccessful ideas, not championing someone else's successful ideas and not championing someone else's unsuccessful ideas.

16. The system of claim 15, wherein the employees can be ranked based upon the annualized score for ideas.

17. The system of claim 16, wherein the ranking can be displayed as a figure comprising: a bar chart, a pie graph and an annual linear plot.

18. A method of evaluating an employee, comprising:
opening an employee to be evaluated performance file on a periodic basis by an evaluator;
reviewing each characteristic for the employee to be evaluated;
scoring each characteristic for the employee to be evaluated;
saving the characteristics for the employee to be evaluated in the data base; and
comparing the annual scores for the employee to be evaluated for the entire length of employment of the employee.

19. The method of claim 18, wherein the characteristics comprise at least one of the following: accountability, adaptability, attendance, attitude, cooperation, creativeness, dependability, honesty, human relations, idea generation, idea success, idea failure, initiative, intelligence, interpersonal relationships, judgment, leadership, management skill, organization, planning, presentation ability, punctuality, quantity of work, quality of work, reliability, respect for others, and teamwork.

20. The system of claim 1, wherein the plurality of evaluators comprises: a co-worker, a sales person, an engineer, a customer, an employee, a regulatory representative, a legal representative, a researcher, a manager, a marketing person, a key employee, a consultant, a contractor, a supervisor, a supplier and a business group.
